(19) United States
(12) Patent Application Publication
(10) Pub. No.: US 2015/0081685 A1
(43) Pub. Date: Mar. 19, 2015

(54) INTERACTIVE VISUALIZATION SYSTEM AND METHOD

(71) Applicant: BigML, Inc., Corvallis, OR (US)

(72) Inventors: Adam Ashenfelter, Corvallis, OR (US); David Gerster, Corvallis, OR (US); Oscar Rovira, Corvallis, OR (US)

(73) Assignee: BigML, Inc., Corvallis, OR (US)

(21) Appl. No.: 14/495,802

(22) Filed: Sep. 24, 2014

Related U.S. Application Data
(63) Continuation-in-part of application No. 13/667,542, filed on Nov. 2, 2012.
(60) Provisional application No. 61/881,566, filed on Sep. 24, 2013.
(60) Provisional application No. 61/555,615, filed on Nov. 4, 2011.

(51) Int. Cl. G06F 17/30

(52) U.S. Cl. CPC G06F 17/3053
USPC 707/723

(57) ABSTRACT

A system and method generates and displays an interactive space-filling graphical representation of a model based at least in part on a dataset having data items. The space-filling graphical representation may have a plurality of segments arranged to realize a type of visualization and sized in proportion to a number of data items represented by the segment to convey particular information about the dataset.

### PRIORITY INFORMATION

The present disclosure claims priority to U.S. provisional patent application Ser. No. 61/881,566, filed Sep. 24, 2013, and entitled VISUALIZATION FOR DECISION TREES, which is herein incorporated by reference in its entirety.

The present disclosure additionally claims priority to and is a continuation-in-part of patent application Ser. No. 13/667,542, filed Nov. 2, 2012, published May 9, 2013, and entitled METHOD AND APPARATUS FOR VISUALIZING AND INTERACTING WITH DECISION TREES, which, in turn, claims priority to U.S. provisional patent application Ser. No. 61/555,615, filed Nov. 4, 2011, and entitled VISUALIZATION AND INTERACTION WITH COMPACT REPRESENTATIONS OF DECISION TREES, which are herein incorporated by reference in their entirety.

The present disclosure incorporates by reference in their entirety U.S. provisional patent application Ser. No. 61/557,826, filed Nov. 9, 2011, and entitled METHOD FOR BUILDING AND USING DECISION TREES IN A DISTRIBUTED ENVIRONMENT and U.S. provisional patent application Ser. No. 61/557,539, filed Nov. 9, 2011, and entitled EVOLVING PARALLEL SYSTEM TO AUTOMATICALLY IMPROVE THE PERFORMANCE OF DISTRIBUTED SYSTEMS.

### COPYRIGHT NOTICE

© 2012-2013 BigML, Inc. A portion of the present disclosure contains material which is subject to copyright protection. The copyright owner has no objection to the facsimile reproduction by anyone of the present disclosure, as it appears in the Patent and Trademark Office patent file or records, but otherwise reserves all copyright rights whatsoever.

### TECHNICAL FIELD

The present disclosure pertains to systems and methods for visualizing and interacting with decision trees.

### BACKGROUND OF THE INVENTION

Decision trees are a common component of a machine learning system. The decision tree acts as the basis through which systems arrive at a prediction given certain data. At each node of the tree, the system may evaluate a set of conditions, and choose the branch that best matches those conditions. The trees themselves can be very wide and encompass a large number of increasingly branching decision points.

FIG. 1 depicts an example of a decision tree 100 plotted using a graphviz visualization application. Decision tree 100 appears as a thin, blurry, horizontal line due to the large number of decision nodes, branches, and text. A section 102A of decision tree 100 may be visually expanded and displayed as expanded section 102B. However, the expanded decision tree section 102B still appears blurry and undecipherable. A sub-section 104A of decision tree section 102B can be visually expanded a second time and displayed as sub-section 104B. Twice expanded sub-section 104B still appears blurry and is still hard to decipher.

Zooming into increasingly smaller sections may reduce usefulness of the decision tree. For example, the expanded decision tree sections may no longer visually display relationships that appear in the non-expanded decision tree 100. For example, the overall structure of decision tree 100 may visually contrast different decision tree nodes, fields, branches, matches, etc. and help distinguish important data model information. However, as explained above, too many nodes, branches, and text may exist to display the entire structure of decision tree 100 on the same screen.

### BRIEF DRAWINGS DESCRIPTION

FIG. 1 depicts a non-filtered decision tree.

FIG. 2 depicts a decision tree visualization system.

FIG. 3 depicts a decision tree using colors to represent node questions.

FIG. 4 depicts how colors and associated node questions may be represented in the decision tree.

FIG. 5 depicts a decision tree using colors to represent outputs.

FIG. 6 depicts a cropped version of a decision tree that uses branch widths to represent instances of sample data.

FIG. 7 depicts a decision tree displayed with a legend that cross references colors with node questions.

FIG. 8 depicts a popup window displaying a percent of sample data passing through a node.

FIG. 9 depicts a popup window showing node metrics.

FIG. 10 depicts a technique for expanding a selected decision tree node.

FIG. 11 depicts a technique for selectively pruning a decision tree.

FIG. 12 depicts a legend cross referencing node fields with importance values and colors.

FIG. 13 depicts a legend cross referencing node outputs with data count value and colors.

FIG. 14 depicts a decision tree using alpha-numeric characters to represent node questions.

FIG. 15 depicts an example computing device for implementing the visualization system.

FIG. 16A is an embodiment of a prediction tree according to the present invention.

FIG. 16B is an embodiment of a pruned prediction tree according to the present invention.

FIG. 16C is an embodiment of the pruned prediction tree shown in FIG. 16B showing a pop up window according to the present invention.

FIG. 16D is an embodiment of a further pruned prediction tree according to the present invention.

FIG. 16E is an embodiment of the further pruned prediction tree shown in FIG. 16D showing a pop up window according to the present invention.

FIG. 16F is an embodiment of an even further pruned prediction tree according to the present invention.

FIG. 16G is an embodiment of the even further pruned decision tree shown in FIG. 16F showing a pop up window according to the present invention.

FIG. 16H is an embodiment of a dataset according to the present invention.

FIG. 17A is an embodiment of a split field sunburst according to the present invention.

FIG. 17B is an embodiment of a prediction sunburst according to the present invention.

FIG. 17C is an embodiment of an expected error sunburst according to the present invention.

FIG. 18A is an embodiment of a split field showing a highlighted prediction path sunburst according to the present invention.

FIG. 18B is an embodiment of a pruned sunburst according to the present invention.

FIG. 18C is an embodiment of another pruned sunburst according to the present invention.

FIG. 18D is an embodiment of yet another pruned sunburst according to the present invention.

FIG. 19 is an embodiment of a tree map according to the present invention.

FIG. 20 is an embodiment of an icicle according to the present invention.

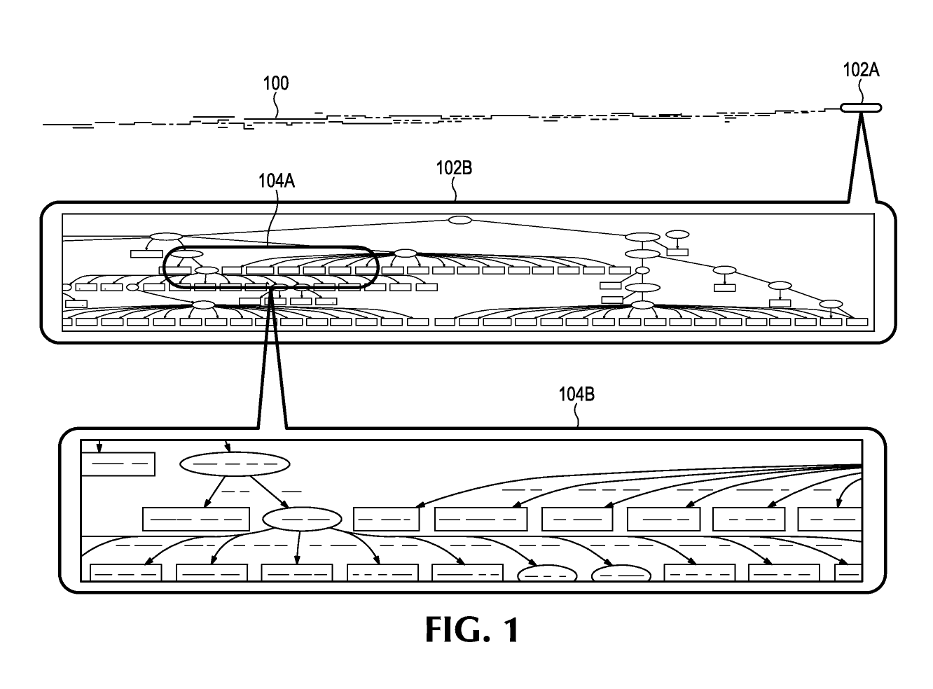

### DETAILED DESCRIPTION OF PREFERRED EMBODIMENTS

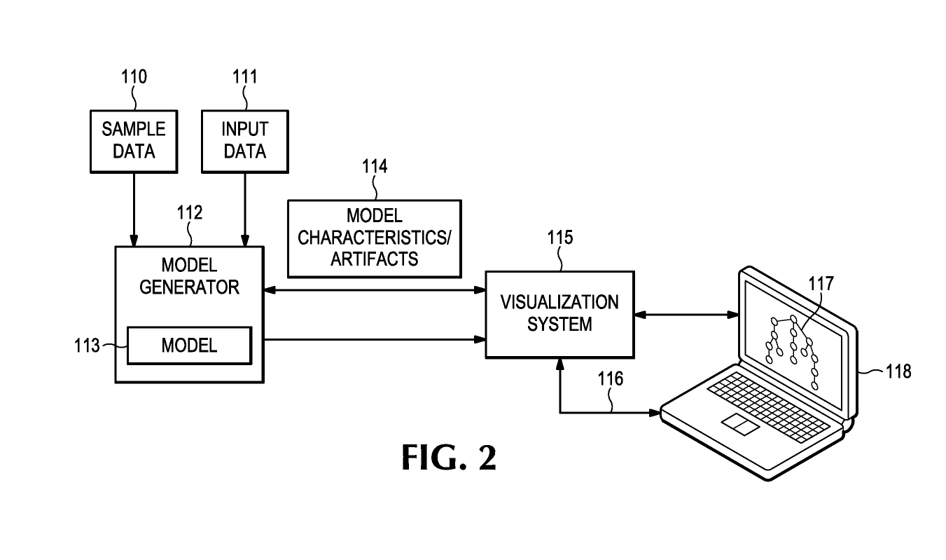

FIG. 2 depicts an example of a visualization system 115 that improves the visualization and understandability of decision trees. A model generator 112 may generate a data model 113 from sample data 110. For example, sample data 110 may comprise census data that includes information about individuals, such as education level, gender, family income history, address, etc. Of course this is just one example of any model that may be generated from any type of data. Sample data may comprise any kind of data hierarchical or otherwise from which model generator 112 may create a data model 113.

Model generator 112 may generate a decision tree 117 that visually represents model 113 as a series of interconnected nodes and branches. The nodes may represent questions and the branches may represent possible answers to the questions. Model 113 and the associated decision tree 117 can then be used to generate predictions or answers for input data 111. For example, model 113 and decision tree 117 may use financial and educational data 111 about an individual to predict a future income level for the individual or generate an answer regarding a credit risk of the individual. Model generators, models, and decision trees are known to those skilled in the art and are therefore not described in further detail.

As explained above, it may be difficult to clearly display decision tree 117 in an original raw form. For example, there may be too many nodes and branches, and too much text to clearly display the entire decision tree 117. A user may try to manually zoom into specific portions of decision tree 117 to more clearly view a subset of nodes and branches. However, zooming into a specific area may prevent a viewer from seeing other more important decision tree information and visually comparing information in different parts of the decision tree.

Visualization system 115 may automatically prune decision tree 117 and only display the most significant nodes and branches. For example, a relatively large amount of sample data 110 may be used for generating or training a first portion of decision tree 117 and a relatively small amount of sample data 110 may be used for generating a second portion of decision tree 117. The larger amount of sample data may allow the first portion of decision tree 117 to provide more reliable predictions than the second portion of decision tree 117.

Visualization system 115 may only display the nodes from decision tree 117 that receive the largest amounts of sample data. This allows the user to more easily view the key questions and answers in decision tree 117. Visualization system 115 also may display the nodes in decision tree in different colors that are associated with node questions. The color coding scheme may visually display node-question relationships, question-answer path relationships, or node-output relationships without cluttering the decision tree with large amounts of text. More generally, visualization system 115 may display nodes or branches with different design characteristics depending on particular attributes of the data. In an embodiment, visualization system 115 may show nodes or branches in different colors depending on an attribute of sample data 110 or input data 111, e.g., age or may show nodes or branches with different design characteristics, e.g., hashed, dashed, or solid lines or thick or thin lines, depending on another attribute of the data, e.g., sample size, number of instances, and the like.

Visualization system 115 may vary how decision tree 117 is pruned, color coded, and generally displayed on a computer device 118 based on model artifacts 114 and user inputs 116. Model artifacts 114 may comprise any information or metrics that relate to model 113 generated by model generator 112. For example, model artifacts 114 may identify the number of instances of sample data 110 received by particular nodes within decision tree 117, the fields and outputs associated with the nodes, and any other metric that may indicate importance levels for the nodes.

Instances may refer to any data that can be represented as a set of attributes. For example, an instance may comprise a credit record for an individual and the attributes may include age, salary, address, employment status, etc. In another example, the instance may comprise a medical record for a patient in a hospital and the attributes may comprise age, gender, blood pressure, glucose level, etc. In yet another example, the instance may comprise a stock record and the attributes may comprise an industry identifier, a capitalization value, and a price to earnings ratio for the stock.

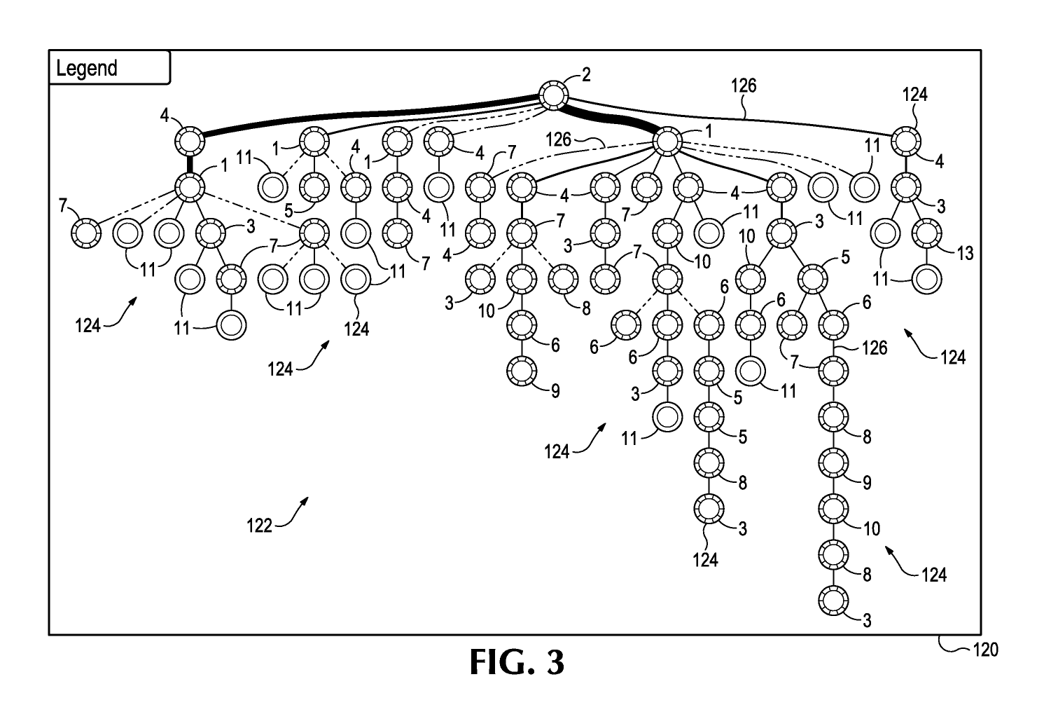

FIG. 3 depicts an example decision tree 122 generated by the visualization system and displayed in an electronic page 120. The decision tree 122 may comprise a series of nodes 124 connected together via branches 126. Nodes 124 may be associated with questions, fields and/or branching criteria and branches 126 may be associated with answers to the node questions. For example, a node 124 may ask the question is an individual over the age of 52. A first branch 126 connected to the node 124 may be associated with a yes answer and a second branch 126 connected to the node 124 may be associated with a no answer.

For explanation purposes, any field, branching criteria, or any other model parameters associated with a node may be referred to generally as a question and any parameters, data or other branching criteria used for selecting a branch will be referred to generally as an answer.

As explained above, the visualization system 115 may automatically prune decision tree 122 and not show all of the nodes and branches that originally existed in the raw non-modified decision tree model. Pruned decision tree 122 may include fewer nodes than the original decision tree but may be easier to understand and display the most significant portions of the decision tree. Nodes and branches for some decision tree paths may not be displayed at all. Other nodes may be displayed but the branches and paths extending from those nodes may not be displayed.

For example, the model generator may generate an original decision tree from sample data containing records for 100 different individuals. The record for only one individual may pass through a first node in the original decision tree. Dozens of records for other individuals may pass through other nodes in the original decision tree. The visualization system 115 may automatically prune the first node from decision tree 122.

In addition to being too large, raw decision trees may be difficult to interpret because of the large amounts of textual information. For example, the textual information may identify the question, field, and/or branching criteria associated with the nodes. Rather than displaying text, the visualization system may use a series of colors, shades, images, symbols, or the like, or any combination thereof to display node information.

For illustrative purposes, reference numbers are used to represent different colors. For example, some nodes 124 may be displayed with a color 1 indicating a first question/field/criteria. A second set of nodes 124 may be displayed with a color 2 indicating a second question/field/criteria, etc.

Nodes 124 with color 1 may ask a same first question, such as the salary of an individual and all of nodes 124 with color 2 may ask a same second question, such as an education level of the individual. Nodes 124 with the same color may have different thresholds or criteria. For example, some of nodes 124 with color 1 may ask if the salary for the individual is above $50K per year and other nodes 124 with color 1 may ask if the salary of the individual is above $80K.

The number of node colors may be limited to maintain the ability to discriminate between the colors. For example, only nodes 124 and associated with a top ten key questions may be assigned colors. Other nodes 124 may be displayed in decision tree 122 but may be associated with questions that did not receive enough sample data to qualify as one of the top ten key questions. Nodes 124 associated with the non-key questions may all be assigned a same color or may not be assigned any color.

Instead of being associated with questions, some nodes 124 in decision tree 124 may be associated with answers, outcomes, predictions, outputs, etc. For example, based on the questions and answers associated with nodes along a path, some nodes 124 may generate an answer “bad credit” and other nodes may generate an answer “good credit.” These nodes 124 are alternatively referred to as terminal nodes and may be assigned a different shape and/or color than the branching question nodes.

For example, the center section of all terminal nodes 124 may be displayed with a same color 11. In addition, branching nodes 124 associated with questions may be displayed with a hatched outline while terminal nodes 124 associated with answers, outcomes, predictions, outputs, etc. may be displayed with a solid outline. For explanation purposes, the answers, outcomes, predictions, outputs, etc. associated with terminal nodes may be referred to generally as outputs.

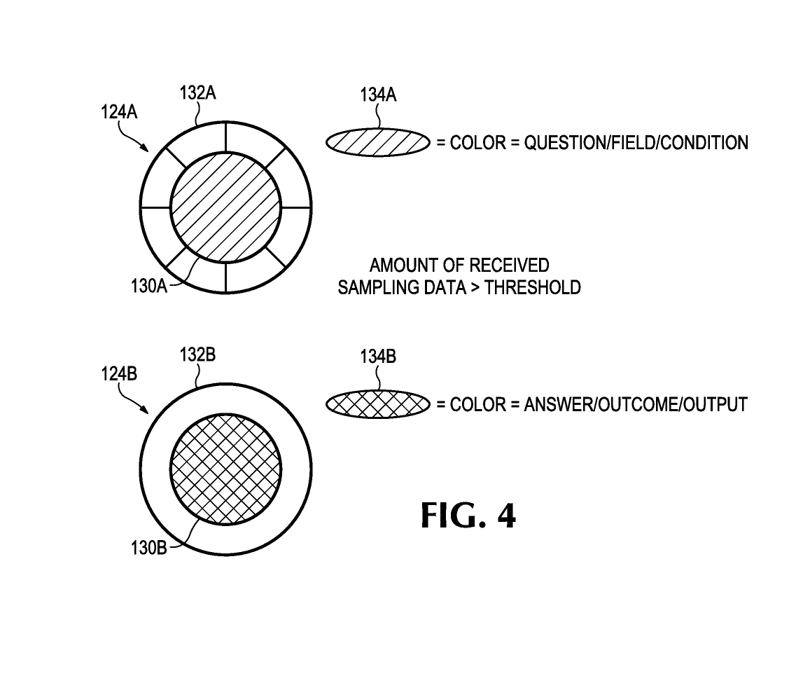

FIG. 4 depicts in more detail examples of two nodes 124 that may be displayed in decision tree 122 of FIG. 3. A branching node 124A may comprise a dashed outer ring 132A with a hatched center section 130A. The dashed outer ring 132A may visually indicate node 124A is a branching node associated with a question, field and/or condition. A color 134A within center section 130A is represented by hatched lines and may represent the particular question, field, and/or criteria associated with node 124A. For example, the question or field may be age and one example of criteria for selecting different branches connected to the node may be an age of 52 years.

Color 134A not only visually identifies the question associated with the node but also may visually identify the question as receiving more than some threshold amount of the sample data during creation of the decision tree model. For example, only the nodes associated with the top ten model questions may be displayed in decision tree 122. Thus, each of nodes 124A in the decision tree will be displayed with one of ten different colors.

A terminal node 124B may comprise a solid outer ring 132B with a cross-hatched center section 130B. A color 134B within center section 130B is represented by the cross-hatched lines. The solid outer ring 132B and color 130B may identify node 124B as a terminal node associated with an answer, outcome, prediction, output, etc. For example, the output associated with terminal node 124B may comprise an income level for an individual or a confidence factor a person is good credit risk.

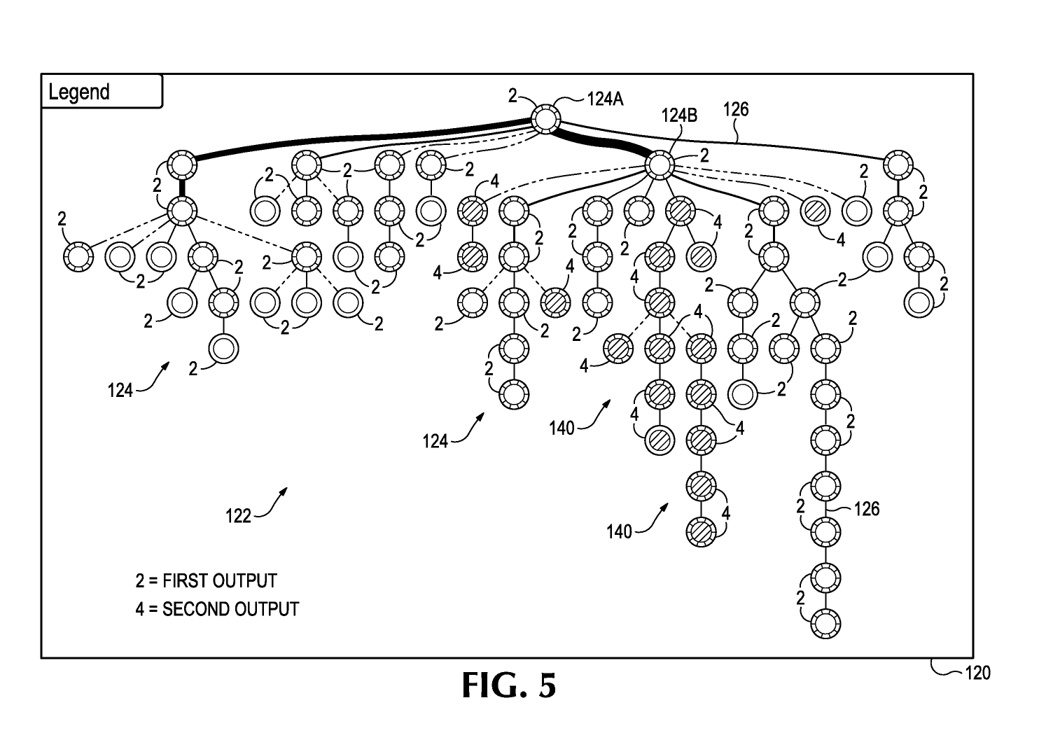

FIG. 5 depicts another example decision tree visualization generated by the visualization system. In this example, a second visualization mode is used for encoding model information. The visualization system may initially display decision tree 122 with the color codes shown in FIG. 3. In response to a user input, the visualization system may toggle to display decision tree 122 with the color codes shown in FIG. 5.

Decision tree 122 in FIG. 5 may have the same organization of nodes 124 and branches 126 previously shown in FIG. 3. However, instead of the colors representing questions, the colors displayed in FIG. 5 may be associated with answers, outcomes, predictions, outputs, etc. For example, a first set of nodes 124 may be displayed with a first color 2 and a second set of nodes 124 may be displayed with a second color 4. Color 2 may be associated with the output “good credit” and color 4 may be associated with the output “bad credit.” Any nodes 124 within paths of decision tree 122 that result in the “good credit” output may be displayed with color 2 and any nodes 124 within paths of decision tree 122 that result in the “bad credit” output may be displayed with color 4.

A cluster 140 of bad credit nodes with color 4 are displayed in a center portion of decision tree 122. A user may mouse over cluster 140 of nodes 124 and view the sequence of questions that resulted in the bad credit output. For example, a first question associated with node 124A may be related to employment status and a second question associated with a second lower level node 124B may be related to a credit check. The combination of questions for nodes 124A and 124B might identify the basis for the bad credit output associated with node cluster 140.

The visualization system may generate the colors associated with the outputs based on a percentage of sample data instances that resulted in the output. For example, 70 percent of the instances applied to a particular node may have resulted in the “good credit” output and 30 percent of the instances through the same node may have resulted in the “bad credit” output. The visualization system may assign the color 2 to the node indicating a majority of the outputs associated with the node are “good credit.”

In response to a second user input, the visualization system may toggle back to the color coded questions shown in FIG. 3. The visualization system may display other information in decision tree 122 in response to preconfigured parameters or user inputs. For example, a user may direct the visualization system to only display paths in decision tree 122 associated with the “bad credit” output. In response to the user input, the visualization system may filter out all of the nodes in decision tree 122 associated with the “good credit” output. For example, only the nodes with color 4 may be displayed.

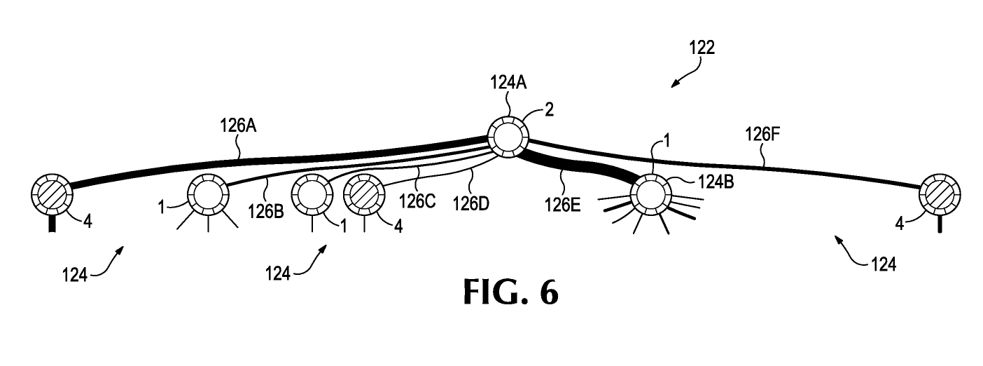

FIG. 6 depicts an example of how the visualization system displays amounts of sample data used for creating the decision tree. As discussed above, decision tree 122 may be automatically pruned to show only the most significant nodes 124 and branches 126. The visualization system may vary the width of branches 126 based on the amounts of sample data received by different associated nodes 124.

For example, a root level of decision tree 122 is shown in FIG. 6 and may have six branches 126A-126F. An order of thickest branch to thinnest branch comprises branch 126E, branch 126A, branch 126F, branch 126B, branch 126C, and branch 126D. In this example, the most sample data may have been received by node 124B. Accordingly, the visualization system displays branch 126E as the widest or thickest branch.

Displaying the branch thicknesses allow users to more easily extract information from the decision tree 122. For example, node 124A may be associated with an employment question, node 124B may be associated with a credit question, and branch 126E may be associated with an answer of being employed for less than 1 year. Decision tree 122 shows that the largest amount of the sample data was associated with persons employed for less than one year.

The thickness of branches 126 also may visually indicate the reliability of the outputs generated from different branches and the sufficiency of the sample data used for generating decision tree 122. For example, a substantially larger amount of sample data was received by node 124B through branch 126E compared with other nodes and branches. Thus, outputs associated with node 124B and branch 126E may be considered more reliable than other outputs.

A user might also use the branch thickness to identify insufficiencies with the sample data. For example, the thickness of branch 126E may visually indicate 70 percent of the sample data contained records for individuals employed less than one year. This may indicate that the decision tree model needs more sample data for individuals employed for more than one year. Alternatively, a user may be confident that the sample data provides an accurate representation of the test population. In this case, the larger thickness of branch 126E may simply indicate that most of the population is usually only employed for less than one year.

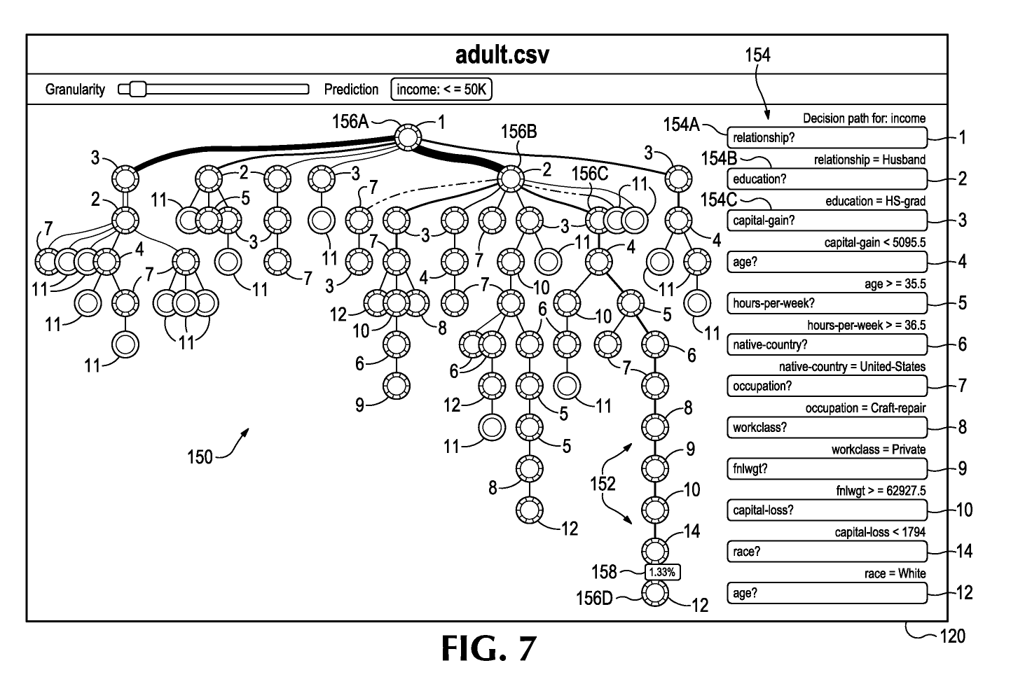

FIG. 7 depicts a scheme for displaying a path through of a decision tree. The colorization schemes described above allow quick identification of important questions. However, a legend 154 also may be used to visually display additional decision tree information.

For example, a user may select or hover a cursor over a particular node within a decision tree 150, such as node 156D. The visualization system may identify a path 152 from selected node 156D to a root node 156A. The visualization system then may display a color coded legend 154 on the side of electronic page 120 that contains all of the questions and answers associated with all of the nodes within path 152.

For example, a relationship question 154A associated with root node 156A may be displayed in box with color 1 and node 156A may be displayed with color 1. An answer of husband to relationship question 154A may cause the model to move to a node 156B. The visualization system may display question 154B associated with node 156B in a box with the color 2 and may display node 156B with color 2. An answer of high school to question 154B may cause the model to move to a next node 156C. The visualization system may display a capital gain question 154C associated with node 156C with the color 3 and may display node 156C with color 3.

The visualization system may display other metrics or data values 158. For example, a user may reselect or continue to hover the cursor over node 156D or may select a branch connected to node 156D. In response to the user selection, the visualization system may display a popup window that contains data 158 associated with node 156D. For example, data 158 may indicate that 1.33% of the sample data instances reached node 156D. As mentioned above, instances may comprise any group of information and attributes used for generating decision tree 150. For example, an instance may be census data associated with an individual or may be financial information related to a stock.

Thus, legend 154 displays the status of all the records at a split point along path 152, such as relationship=Husband. Legend 154 also contains the question/field to be queried at the each level of decision tree path 152, such as capital-gain. Fields commonly used by decision tree 150 and significant fields in terms of maximizing information gain that appear closer to root node 156A can also be quickly viewed.

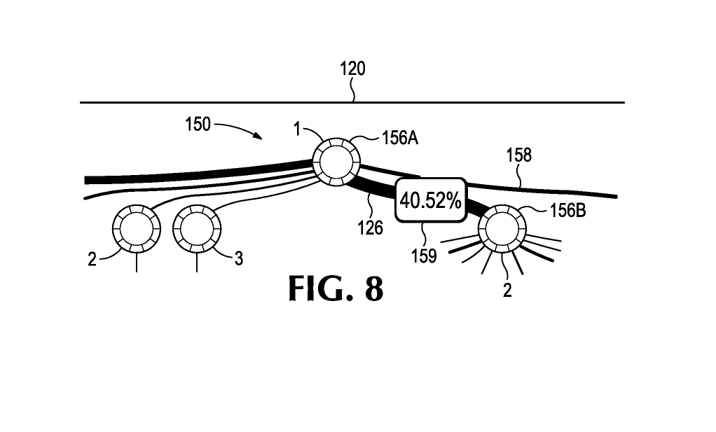

FIG. 8 depicts another example of how the visualization system may display metrics associated with a decision tree. As described above in FIG. 7, the visualization system may display a contextual popup window 159 in response to a user selection, such as moving a cursor over a node 156B or branch 126 and pressing a select button. Alternatively, the visualization system may display popup window 159 when the user hovers the cursor over node 156B or branch 126 for some amount of time or selects node 156B or branch 126 via a keyboard or touch screen.

Popup window 159 may display numeric data 158 identifying a percentage of records (instances) in the sample data that passed through node 156B during the model training process. The record information 158 may help a user understand other aspects of the underlying sample data. Data 158 may correspond with the width of branch 126. For example, the width of branch 126 visually indicates node 156B received a relatively large percentage of the sample data. Selecting node 156B or branch 126 causes the visualization system to display popup window 159 and display the actual 40.52% of sample data that passed through node 156B.

Any other values or metrics can be displayed within popup window 159, such as average values or other statistics related to questions, fields, outputs, or attributes. For example, the visualization system may display a dropdown menu within popup window 159. The user may select different metrics related to node 156B or branch 126 for displaying via selections in the dropdown menu.

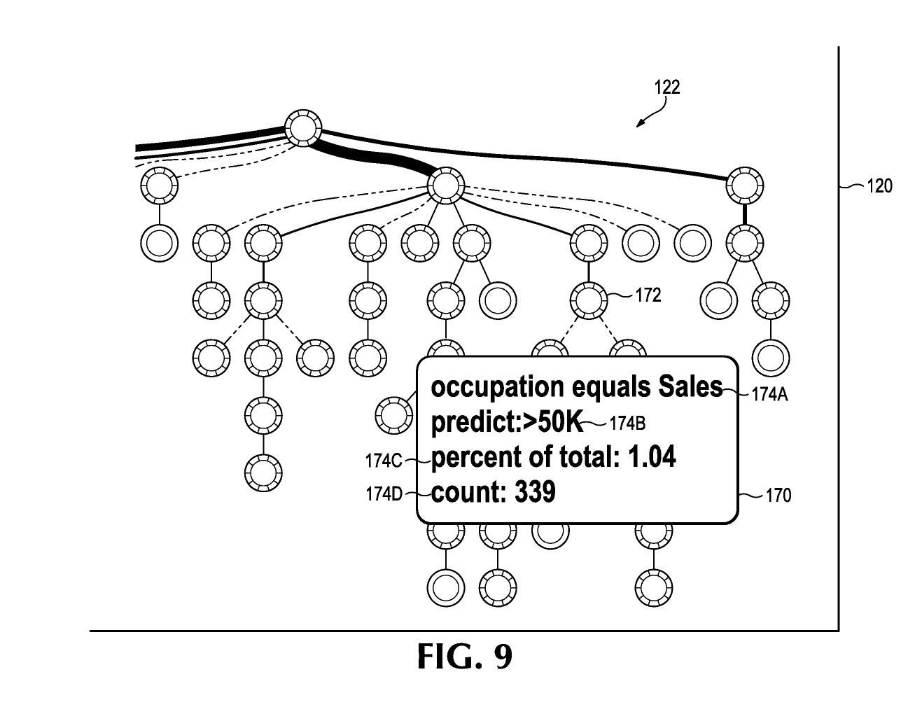

FIG. 9 depicts another popup window 170 that may be displayed by the visualization system in response to the user selecting or hovering over a node 172. Popup window 170 may display text 174A identifying the question associated with node 172 and display text 174B identifying a predicted output associated with node 172. Popup window 170 also may display text 174D identifying a number of sample data instances received by node 172 and text 174C identifying a percentage of all sample data instances that were passed through node 172.

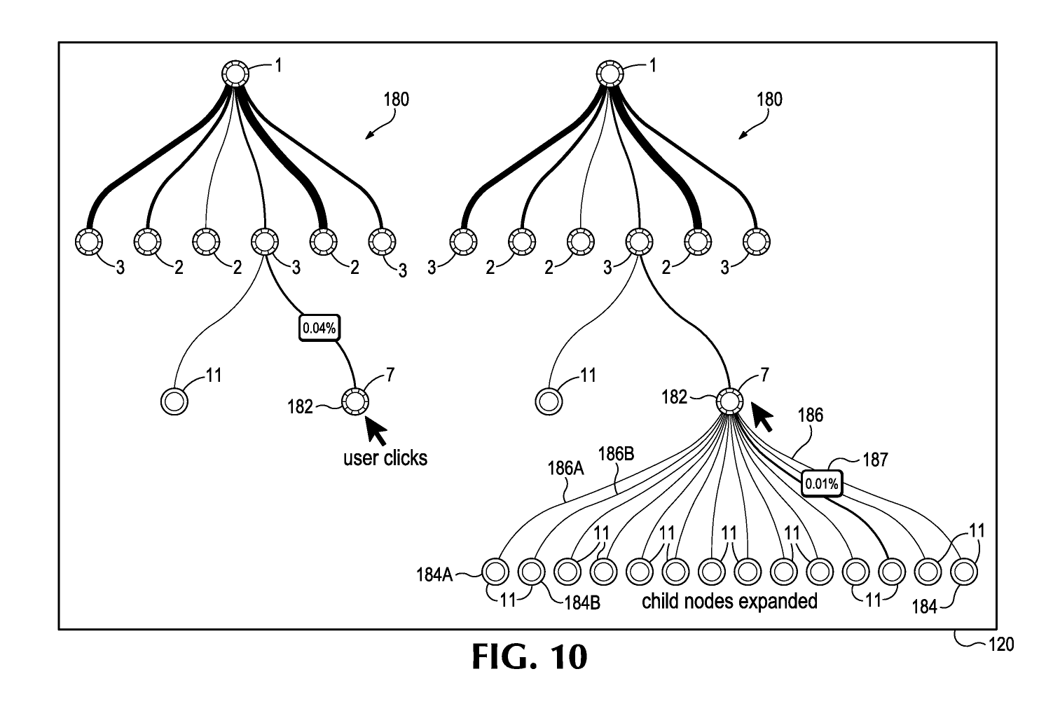

FIG. 10 depicts how the visualization system may selectively display different portions of a decision tree. As described above, the visualization system may initially display a most significant portion of a decision tree 180. For example, the visualization system may automatically prune decision tree 180 by filtering child nodes located under a parent node 182. A user may wish to expand parent node 182 and view any hidden child nodes.

In response to the user selecting or clicking node 182, the visualization system may display child nodes 184 connected below parent node 182. Child nodes 184 may be displayed with any of the color and/or symbol coding described above. In one example, the visualization system may isolate color coding to child nodes 184. For example, the top ranked child nodes 184 may be automatically color coded with associated questions. The visualization system also may display data 187 related to child nodes 184 in popup windows in response to the user selecting or hovering over child nodes 184 or selecting branches 186 connected to child nodes 184.

In order to keep the decision tree from getting too dense, branches 186 of the child node subtree may be expanded one at a time. For example, selecting parent node 182 may display a first branch 186A and a first child node 184A. Selecting parent node 182 a second time may display a second branch 186B and a second child node 184B.

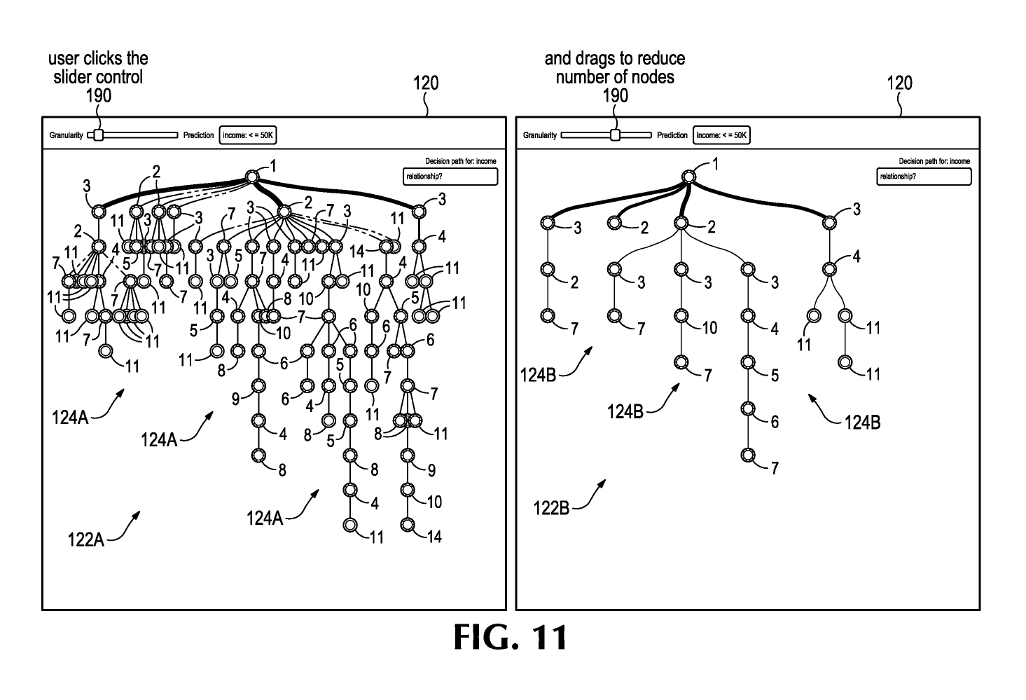

FIG. 11 depicts another example of how the visualization system may selectively prune a decision tree. The visualization system may display a preselect number of nodes 124A in decision tree 122A. For example, the visualization system may identify 100 nodes from the original decision tree that received the highest amounts of sample data and display the identified nodes 124A in decision tree 122A.

A user may want to selectively prune the number of nodes 124 that are displayed in decision tree 122B. This may greatly simplify the decision tree model. An electronic image or icon represents a slider 190 and may be used for selectively varying the number of nodes displayed in the decision tree. As mentioned above, the top 100 nodes 124A may be displayed in decision tree 122A. Moving slider 190 to the right may cause the visualization system to re-pruned decision tree 124A into decision tree 124B with a fewer nodes 124B.

For example, the visualization system then may identify a number of nodes to display in decision tree 122B based on the position of slider 190, such as 20 nodes. The visualization system may then identify the 20 nodes and/or 20 questions that received the largest amount of sample data and display the identified nodes 124B in decision tree 122B. The visualization system may display nodes 124B with colors corresponding with the associated node questions. The visualization system also may display any of the other information described above, such as color coded outputs and/or popup windows that display other mode metrics.

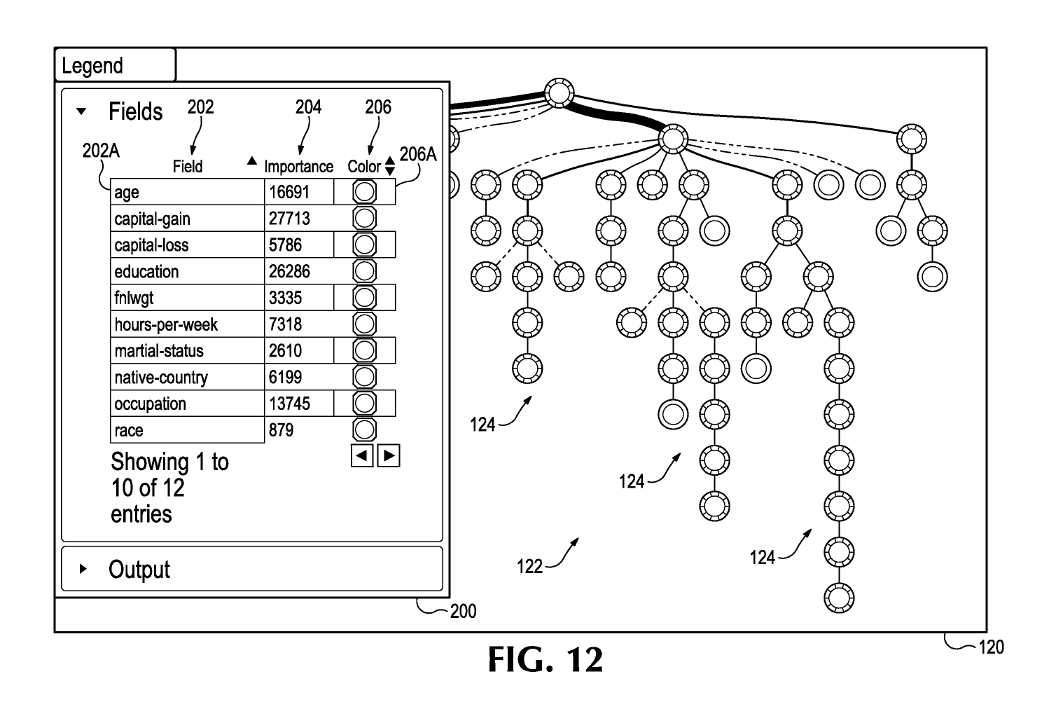

FIG. 12 depicts another example of how the visualization system may display a decision tree. The colorization techniques described above allow the important fields to be quickly identified. The visualization system may display a legend 200 that shows the mapping of colors 206 with corresponding fields 202. Legend 200 may be used for changing colors 206 assigned to specific questions/fields 202 or may be used to change an entire color scheme for all fields 202. For example, selecting a particular field 202A on legend 200 may switch the associated color 206A displayed for nodes 124 associated with field 202A.

Legend 200 also may display values 204 associated with the importance 204 of different fields/questions/factors 202 used in a decision tree 122. For example, decision tree 122 may predict salaries for individuals. Field 202A may have an importance value of 16691 which appears to have the third highest importance within fields 202. Thus, age field 202A may be ranked as the third most important question/field in decision tree 122 for predicting the salary of an individual. Any statistics can be used for identifying importance values 204. For example, importance values 204 may be based on the confidence level for fields 202.

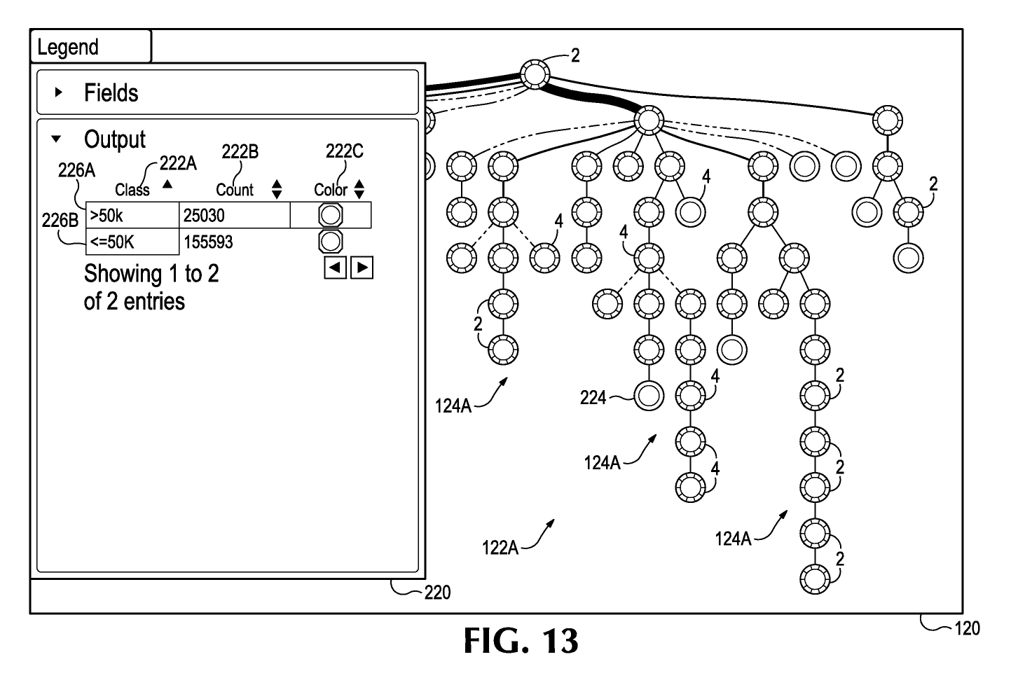

FIG. 13 depicts another example of how output information may be displayed with a decision tree. A legend 220 may be displayed in response to a user selecting a given node. In this example, the user may have selected a node 224 while operating in the output mode previously described in FIG. 5. Accordingly, the visualization system may display legend or window 220 containing output metrics associated with node 224.

For example, legend 220 may display outputs or classes 222A associated with node 224 or the output associated with node 224, a count 222B identifying a number of instances of sample data that generated output 222A, and a color 222C associated with the particular output. In this example, an output 226A of >50K may have a count 222B of 25030 and an output 226B of ≦50K may have a count 222B of 155593.

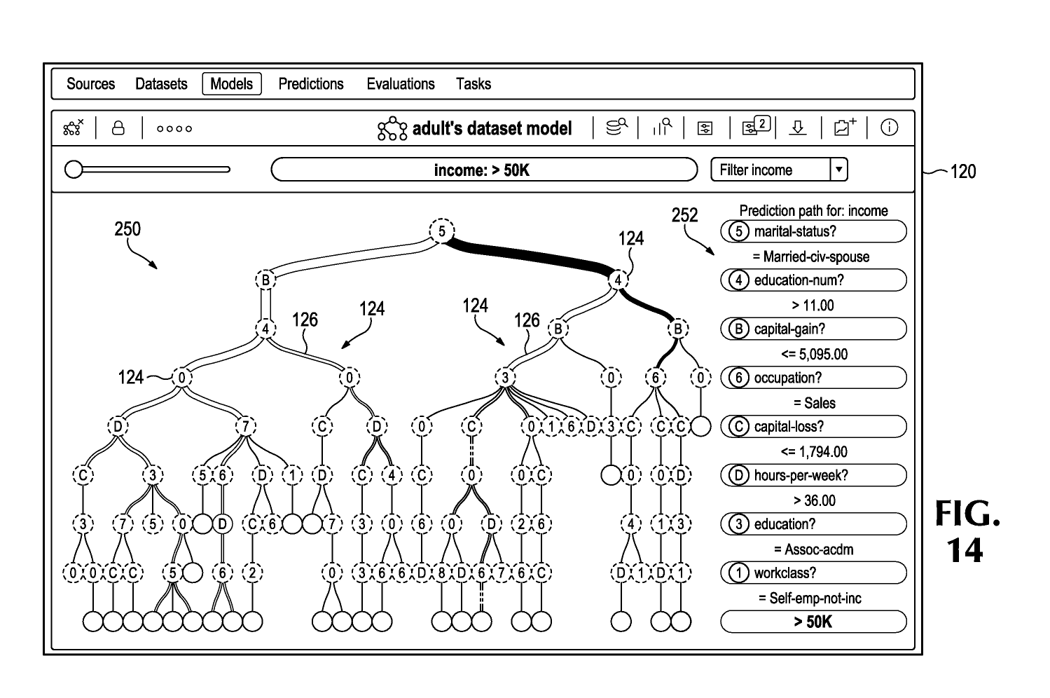

FIG. 14 depicts an alternative example of how questions and answers may be visually displayed in a decision tree 250. In this example, instead of colors, numbers and/or letters may be displayed within nodes 124. The alphanumeric characters may represent the questions, fields, conditions and/or outputs associated with the nodes and associated branches 126. A legend 252 may be selectively displayed on the side of electronic page 120 that shows the mappings between the alphanumeric characters and the questions, fields, answers, and outputs. Dashed outlines circles again may represent branching nodes and solid outlined circles may represent terminal/output nodes.

Hardware and Software

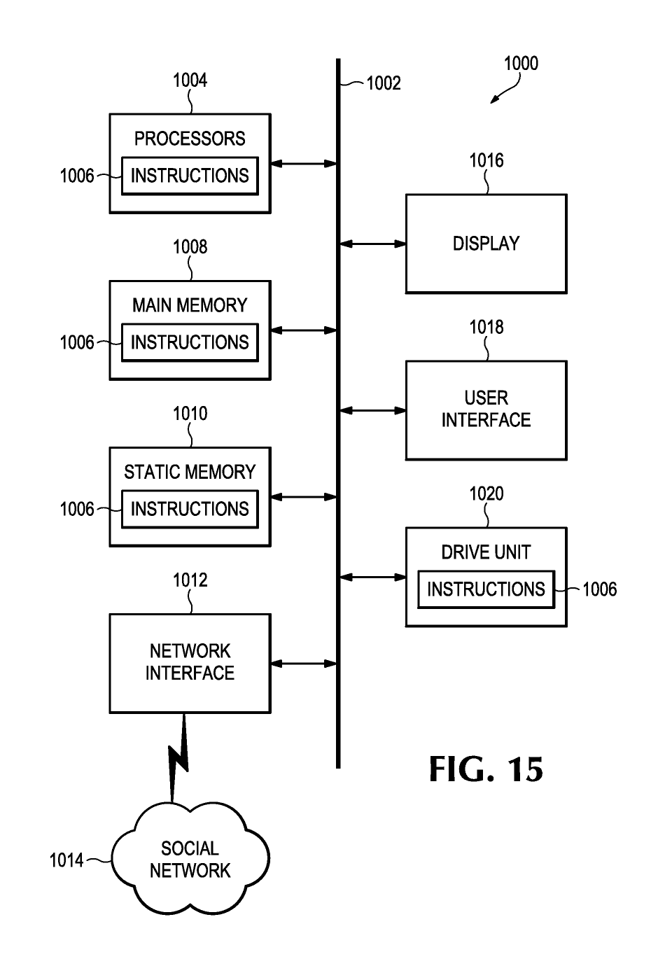

FIG. 15 shows a computing device 1000 that may be used for operating the visualization system and performing any combination of the visualization operations discussed above. The computing device 1000 may operate in the capacity of a server or a client machine in a server-client network environment, or as a peer machine in a peer-to-peer (or distributed) network environment. In other examples, computing device 1000 may be a personal computer (PC), a tablet, a Personal Digital Assistant (PDA), a cellular telephone, a smart phone, a web appliance, or any other machine or device capable of executing instructions 1006 (sequential or otherwise) that specify actions to be taken by that machine.

While only a single computing device 1000 is shown, the computing device 1000 may include any collection of devices or circuitry that individually or jointly execute a set (or multiple sets) of instructions to perform any one or more of the operations discussed above. Computing device 1000 may be part of an integrated control system or system manager, or may be provided as a portable electronic device configured to interface with a networked system either locally or remotely via wireless transmission.

Processors 1004 may comprise a central processing unit (CPU), a graphics processing unit (GPU), programmable logic devices, dedicated processor systems, micro controllers, or microprocessors that may perform some or all of the operations described above. Processors 1004 may also include, but may not be limited to, an analog processor, a digital processor, a microprocessor, multi-core processor, processor array, network processor, etc.

Some of the operations described above may be implemented in software and other operations may be implemented in hardware. One or more of the operations, processes, or methods described herein may be performed by an apparatus, device, or system similar to those as described herein and with reference to the illustrated figures.

Processors 1004 may execute instructions or “code” 1006 stored in any one of memories 1008, 1010, or 1020. The memories may store data as well. Instructions 1006 and data can also be transmitted or received over a network 1014 via a network interface device 1012 utilizing any one of a number of well-known transfer protocols.

Memories 1008, 1010, and 1020 may be integrated together with processing device 1000, for example RAM or FLASH memory disposed within an integrated circuit microprocessor or the like. In other examples, the memory may comprise an independent device, such as an external disk drive, storage array, or any other storage devices used in database systems. The memory and processing devices may be operatively coupled together, or in communication with each other, for example by an I/O port, network connection, etc. such that the processing device may read a file stored on the memory.

Some memory may be “read only” by design (ROM) by virtue of permission settings, or not. Other examples of memory may include, but may be not limited to, WORM, EPROM, EEPROM, FLASH, etc. which may be implemented in solid state semiconductor devices. Other memories may comprise moving parts, such a conventional rotating disk drive. All such memories may be “machine-readable” in that they may be readable by a processing device.

“Computer-readable storage medium” (or alternatively, “machine-readable storage medium”) may include all of the foregoing types of memory, as well as new technologies that may arise in the future, as long as they may be capable of storing digital information in the nature of a computer program or other data, at least temporarily, in such a manner that the stored information may be “read” by an appropriate processing device. The term “computer-readable” may not be limited to the historical usage of “computer” to imply a complete mainframe, mini-computer, desktop, wireless device, or even a laptop computer. Rather, “computer-readable” may comprise a storage medium that may be readable by a processor, processing device, or any computing system. Such media may be any available media that may be locally and/or remotely accessible by a computer or processor, and may include volatile and non-volatile media, and removable and non-removable media.

Computing device 1000 can further include a video display 1016, such as a liquid crystal display (LCD) or a cathode ray tube (CRT) and a user interface 1018, such as a keyboard, mouse, touch screen, etc. All of the components of computing device 1000 may be connected together via a bus 1002 and/or network.

For the sake of convenience, operations may be described as various interconnected or coupled functional blocks or diagrams. However, there may be cases where these functional blocks or diagrams may be equivalently aggregated into a single logic device, program, or operation with unclear boundaries.

Graphical visualization methods have evolved to assist in the analysis of large datasets that can be particularly challenging to display visually in a meaningful manner. Graphic visualization methods may be interactive based on user input and may include tree visualizations as well as space-filling visualizations, e.g., sunburst, tree map, and icicle visualizations.

An embodiment of the present invention may include a method for interactive visualization of a dataset including accessing a decision tree model of a dataset and generating a space-filling visualization display of the decision tree model. The space-filling visualization may comprise a sunburst which is a radial layout of segments corresponding to nodes (or subset of nodes) of a prediction tree. Each segment in the sunburst has an angular dimension and a color each corresponding or proportional to a metric, e.g., confidence, attribute, and the like, of the corresponding node.

A fundamental element of any visualization is a data source, which may be organized as a table that includes rows that represent a field or a feature. By default, the last field is considered the feature to be predicted termed an objective field. A first row of a data source may be used as a header, i.e., to provide field names or to identify instances. A field can be numerical, categorical, textual, date-time, or otherwise.

For example, a data source for iris flower classification (Table 1) may include rows identifying fields, e.g., sepal length, sepal width, petal length, petal width, species, and the like. Each field may have a corresponding type, e.g., numerical, categorical, textual, date-time, or otherwise. For example, sepal length is a numerical field type, while species is a categorical type. Each field may have associated therewith data items corresponding to one or more instances. For example, instance 1 has a sepal length of 5.1 and a sepal width of 3.5 while instance 2 has a petal length of 1.4 and petal width of 0.2.

TABLE 1
Iris Flower Classification Data Source

| Name | Type | Instance 1 | Instance 2 | Instance 3 |
|---|---|---|---|---|
| Sepal Length | Numerical | 5.1 | 4.9 | 4.7 |
| Sepal Width | Numerical | 3.5 | 3.0 | 3.2 |
| Petal Length | Numerical | 1.4 | 1.4 | 1.3 |
| Petal Width | Numerical | 0.2 | 0.2 | 0.2 |
| Species | Textual | Iris-setosa | Iris-setosa | Iris-setosa |

A dataset, for its part, is a structured version of one or more data sources where each field has been processed and serialized according to its type. A dataset may comprise a histogram for each numerical, categorical, textual, or date-time field. A dataset may show a number of instances, missing values, errors, and a histogram for each field in the dataset. In an embodiment, selecting a histogram by any means, e.g., by clicking on a node using any kind of mouse, hovering over a node for a predetermined amount of time using any kind of cursor, touching a node using any kind of touch screen, gesturing on a gesture sensitive system and the like, may result in display of a pop up window with additional specific information about the selected histogram. In an embodiment, the pop up window over a histogram may show, for each numeric field, the minimum, the mean, the median, maximum, and the standard deviation.

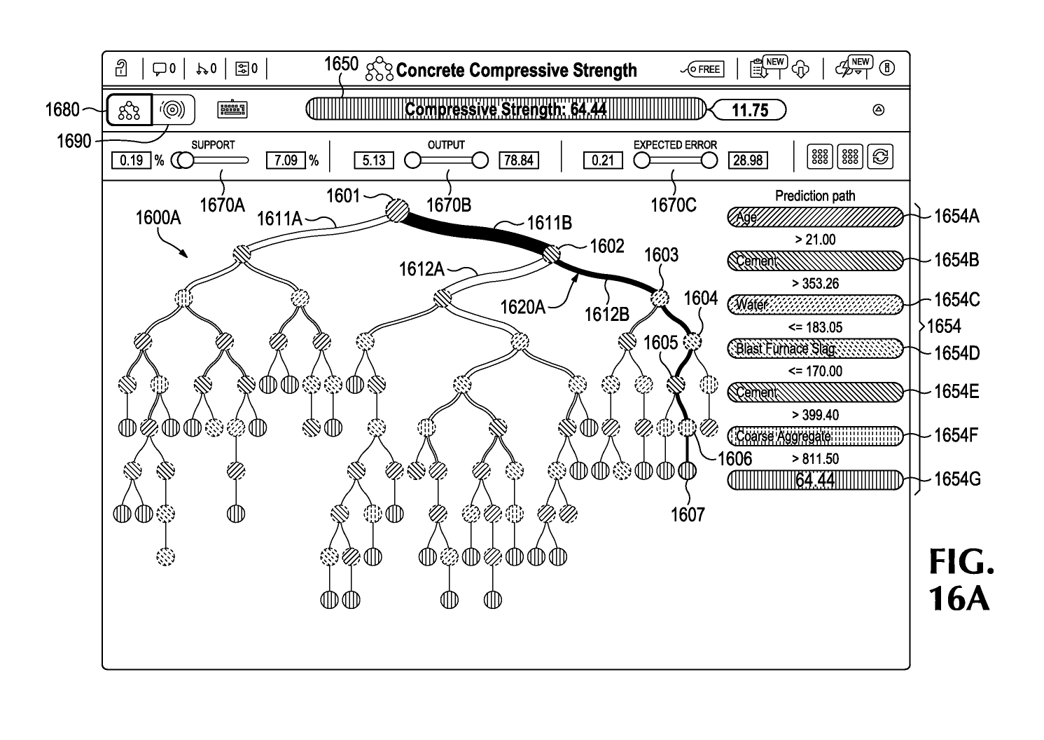

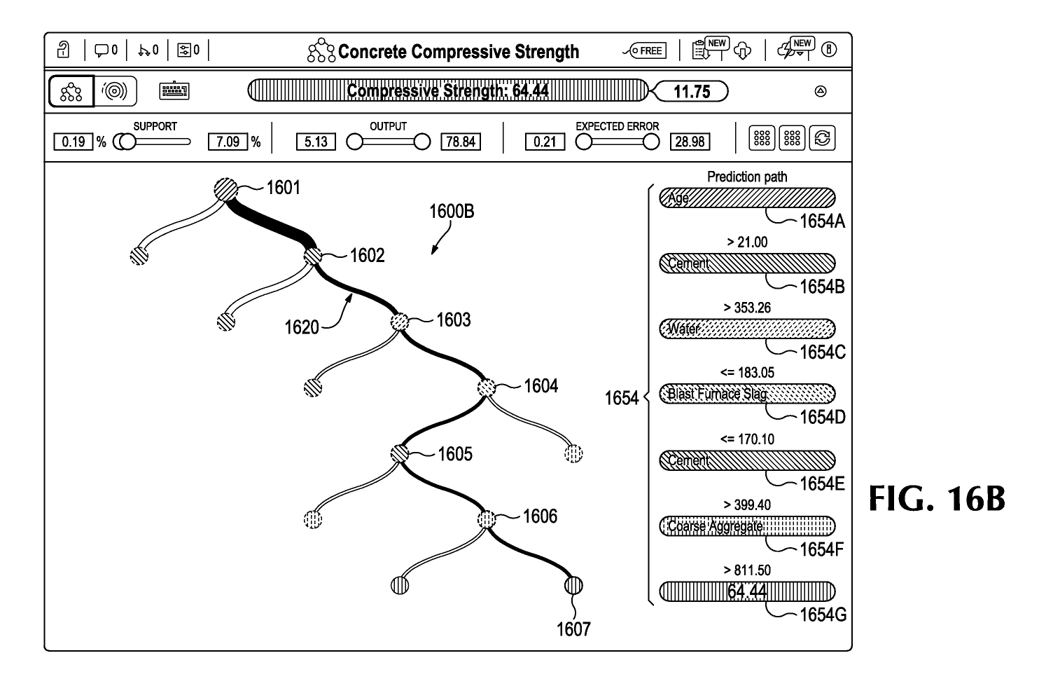

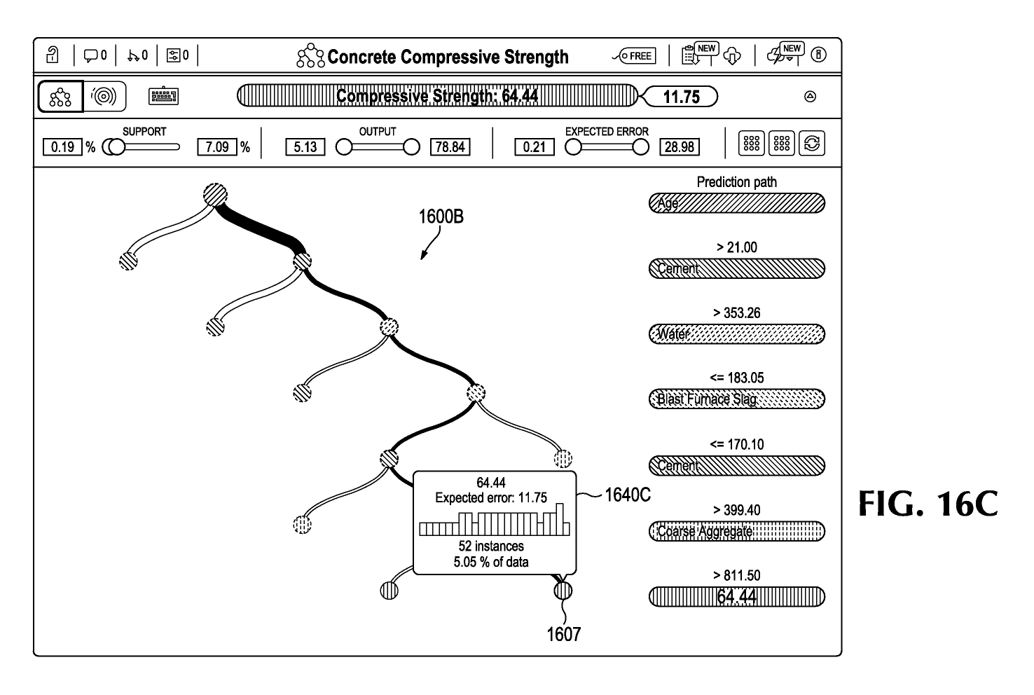

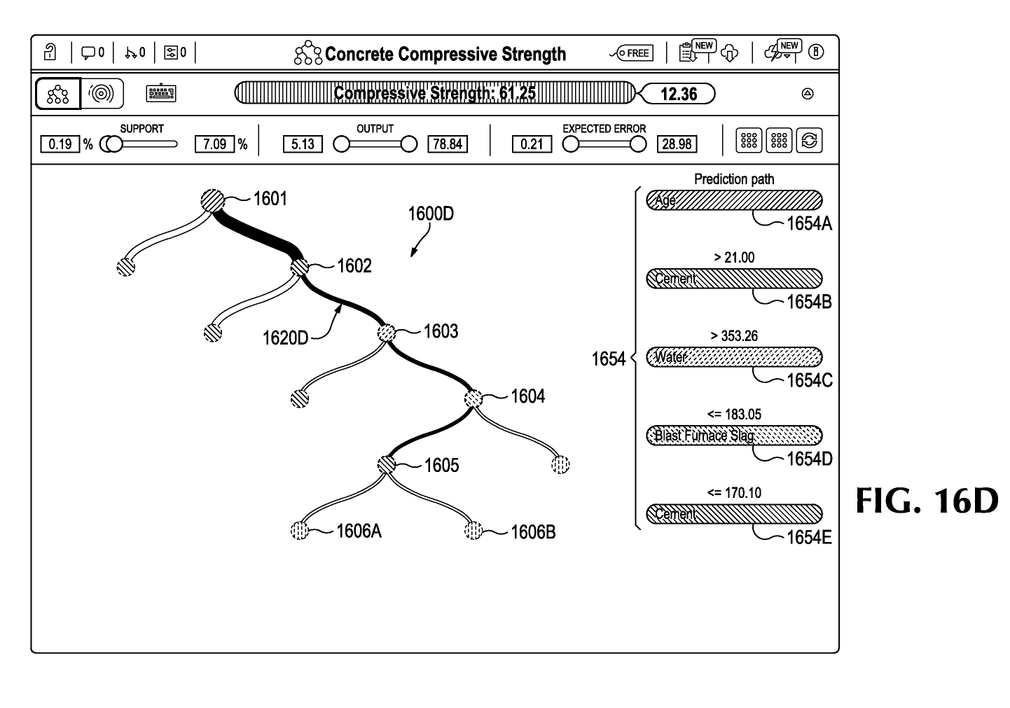

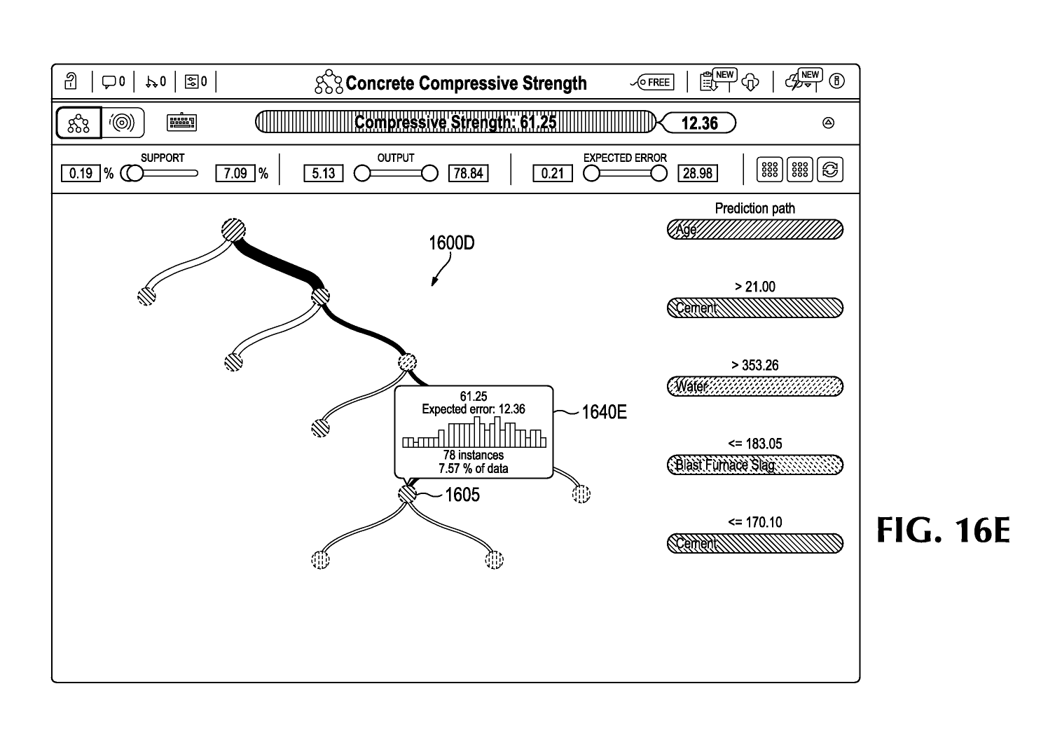

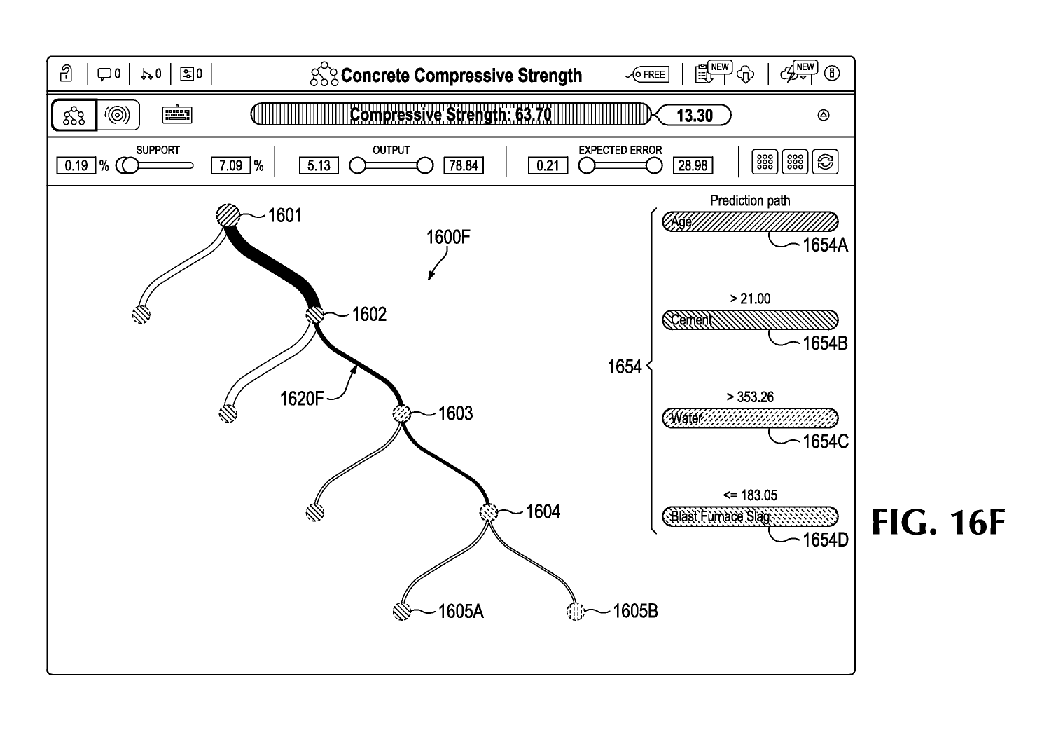

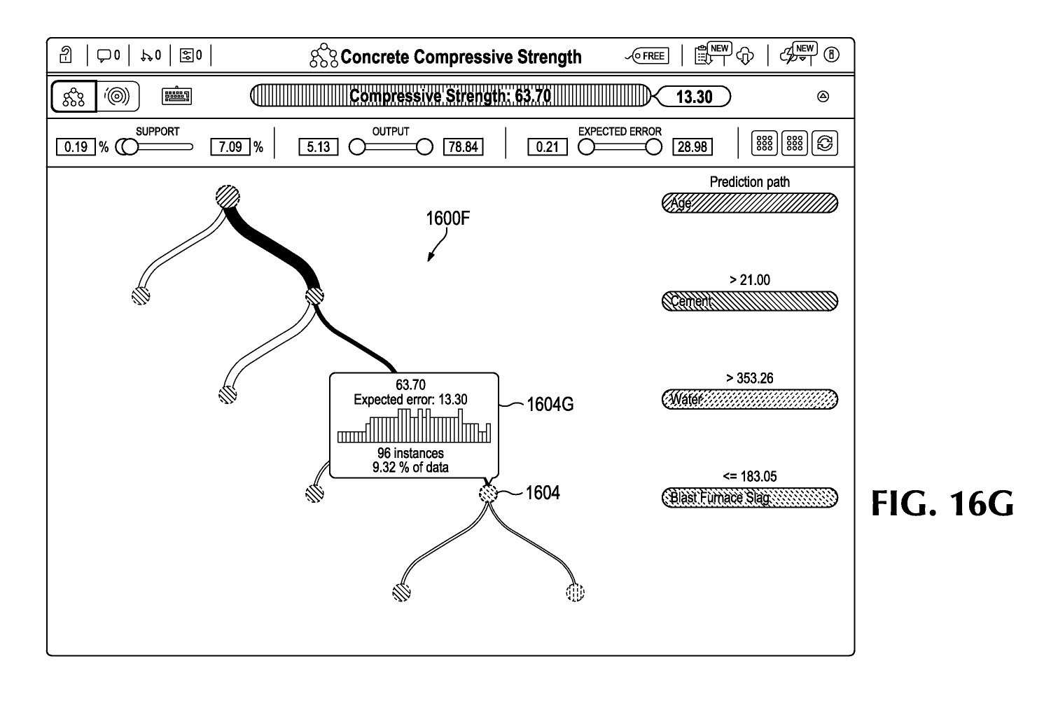

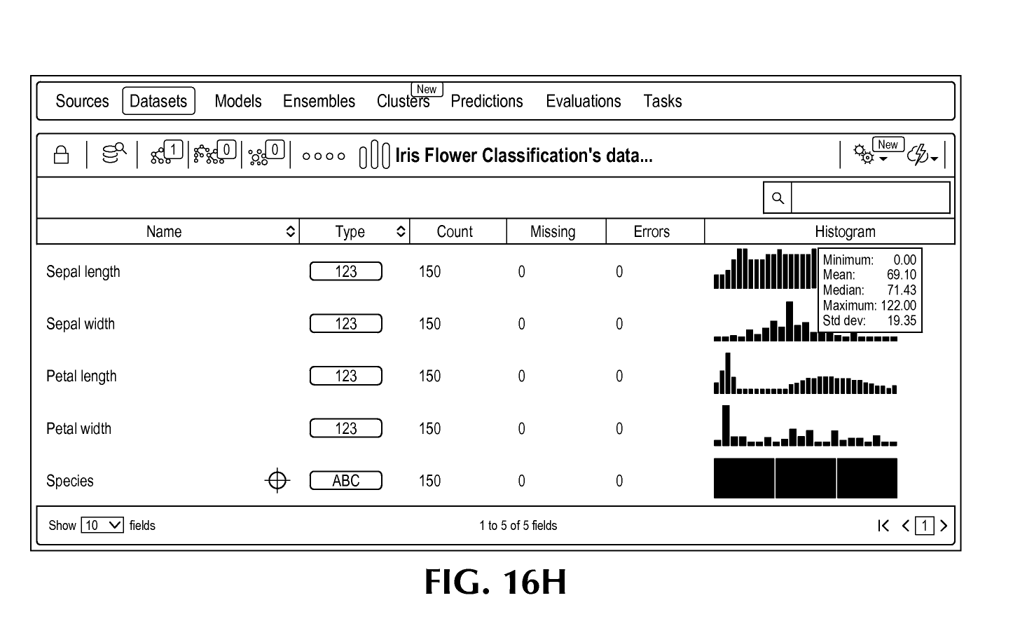

An exemplary dataset for iris flower classification is shown below as Table 2 in FIG. 16H.

Note that a unique symbol or icon [symbol] denotes the species row as the objective field, or the field to be predicted using the model created based on the dataset shown in Table 2.

FIG. 16A is an embodiment of a prediction tree 1600A according to the present invention. Referring to FIGS. 2 and 16A, model generator 112 may generate a model 113 based at least in part a dataset comprising a plurality of data sources, e.g., input data 111 and sample data 110. Visualization system 115, in turn, may generate prediction tree 1600A based on model 113 and, optionally, model characteristics or artifacts 114. In an embodiment, model 113 may predict an objective field, which is a last row of the dataset by default but other rows or columns may be designated as the objective field. A prediction tree may show the most relevant patterns in the data but may also be used to generate predictions for new data instances.

Prediction tree 1600A may include a plurality of nodes, e.g., nodes 1601, 1602, 1603, 1604, 1605, 1606, and 1607, and a plurality of branches, e.g., branches 1611, 1612, and 1613. At every node, visualization system 115 may display prediction tree 1600A together with a prediction of an objective field, e.g., compression strength. Visualization system 115 may display the prediction at an information box 1650, legend 1654, or pop up window 1640 (e.g., FIG. 16C) together with additional information relating to the prediction, e.g., level of confidence or an expected error, in response to a user selecting a particular node by any means known to a person of ordinary skill in the art, e.g., a user clicking on a node using any kind of mouse, a user hovering over a node for a predetermined amount of time using any kind of cursor, a user touching a node using any kind of touch screen, a user using any kind of gesturing on a gesture sensitive system, and the like.

Prediction tree 1600A may have a binary structure meaning that at most, two branches emanate from each node. For example, root node 1601 may include branches 1611A and 1611B, while node 1602 may include branches 1612A and 1612B, and the like. Prediction tree 1600A may include a root node 1601 and any number of terminal nodes, e.g., node 1607.

Each node in prediction tree 1600A may be displayed with a corresponding visual characteristic that differentiates the display of one node from another by visually indicating particular fields. Visual characteristics may include color, cross hatching, or any other characteristic capable of visually differentiating the display of one node from another. For example, root node 1601 may be associated with a first color or cross hatching that indicates an “age” field while node 1602 may be associated with a second color or cross hatching that indicates a “cement” field.

Each branch of prediction tree 1600A may represent a number of data items in the dataset associated with the particular field or attribute represented by the node from which it emanates. In an embodiment, a width of each branch may visually indicate a number of data items associated with the associated branch. For example, branch 1611B is wider than branch 1611A to indicate that a larger number of instances of data items correspond to branch 1611B than correspond to branch 1611A.

Visualization system 115 may visually highlight a prediction path associated with a particular node in response to receiving an indication that a user has selected the particular node. For example, visualization system 115 may prediction path 1620 that includes root node 1601, nodes 1602, 1603, 1604, 1605, and 1606, and terminal node 1607 in response to receiving an indication that a user has selected terminal node 1607. In an embodiment, visualization system 115 may receive an indication that a user has selected a node through any input mechanism known to a person of ordinary skill in the art, including clicking on a node using any kind of mouse, hovering over a node for a predetermined amount of time using any kind of cursor, touching a node using any kind of touch screen, gesturing on a gesture sensitive system, and the like. Prediction path 1620 may be a path from the root node 1601 to the selected particular selected node, e.g., terminal node 1607.

Visualization system 115 may display prediction tree 1600A with a legend 1654 that may display additional information about the nodes and branches in prediction tree 1600A. Legend 1654 may comprise a plurality of boxes, e.g., box 1654A, 1654B, 1654C, and field values, e.g., >21, >355.26, and <=183.05, respectively. Each box and field value, in turn, corresponds to a particular node in prediction tree 1600A. For example, selecting root node 1601 will display box 1654A that indicates the corresponding field as “age.” For another example, selecting node 1602 will display box 1654A indicating a field “age” with a split value of “>21” and a box 1654B indicating a field “cement.” For yet another example, selecting terminal node 1607 will display box 1654A indicating a field “age” with a split value of “>21,” box 1654B indicating a field “cement” with a split value of “>353.26,” box 1654C indicating a field “water” with a split value of “<=183.05,” box 1654D indicating a field “blast furnace slag” with a split value of “<=170.00,” box 1654E indicating a field “cement” with a split value of “>399.40,” box 1654F indicating a field “coarse aggregate” with a split value of “>811.50,” and a prediction box 1654G indicating a prediction for concrete compressive strength for prediction path 1620 of “64.44.”

Visualization system 115 may display legend boxes with a visual characteristic matching the corresponding node, e.g., the cross hatching on box 1654A is the same as that used in root node 1601.

Visualization system 115 may display one or more filtering or pruning mechanisms 1670A, 1670B, and 1670C in which to filter or prune prediction tree 1600A based on various predictive outcomes. Filtering mechanisms 1670A, 1670B, and 1670C are shown as graphical sliders that can be manipulated to show only those nodes and branches associated with particular predictive outcomes. For example, filtering mechanism 1670A is shown as a support slider to show all nodes and branches having data support between 0.19% and 7.09%, filtering mechanism 1670B is an output slider to show all nodes and branches that support compressive strength output between 5.13 and 78.84, and filtering mechanism 1670C is an expected error slider to show the expected error in the compressive strength output between 0.21 and 28.98. Note that in circumstances where the objective field is a categorical field, filtering mechanism 1670C is a confidence level slider to show a confidence level percentage in a particular categorical outcome. Filtering mechanisms 1670A, 1670B, and 1670C may be in any form capable of receiving input for values that may filter or prune prediction tree 1600A.

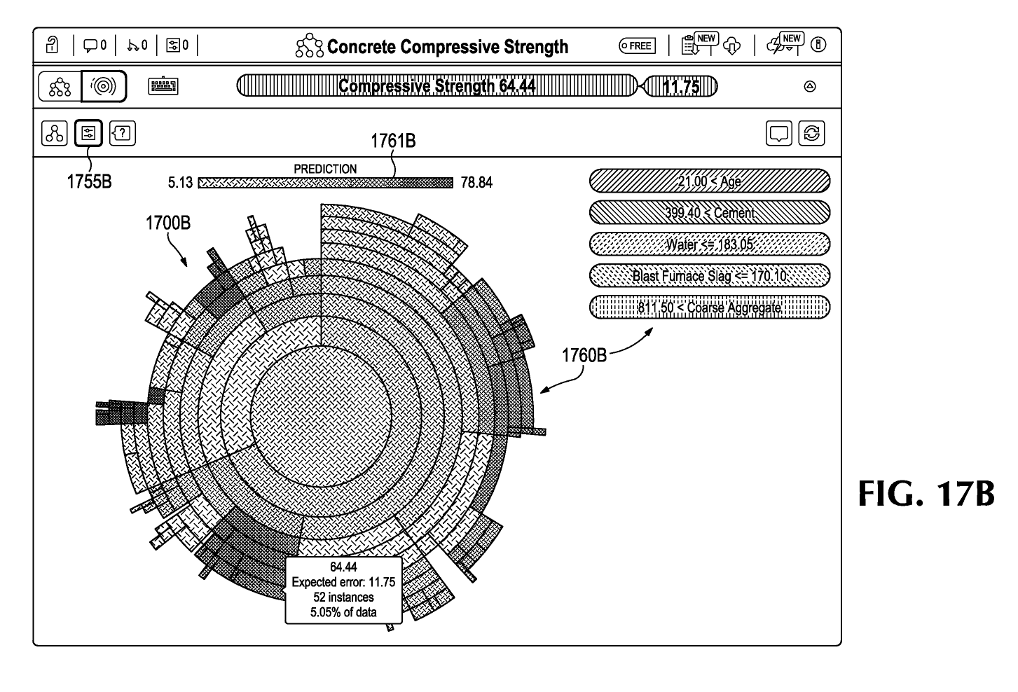

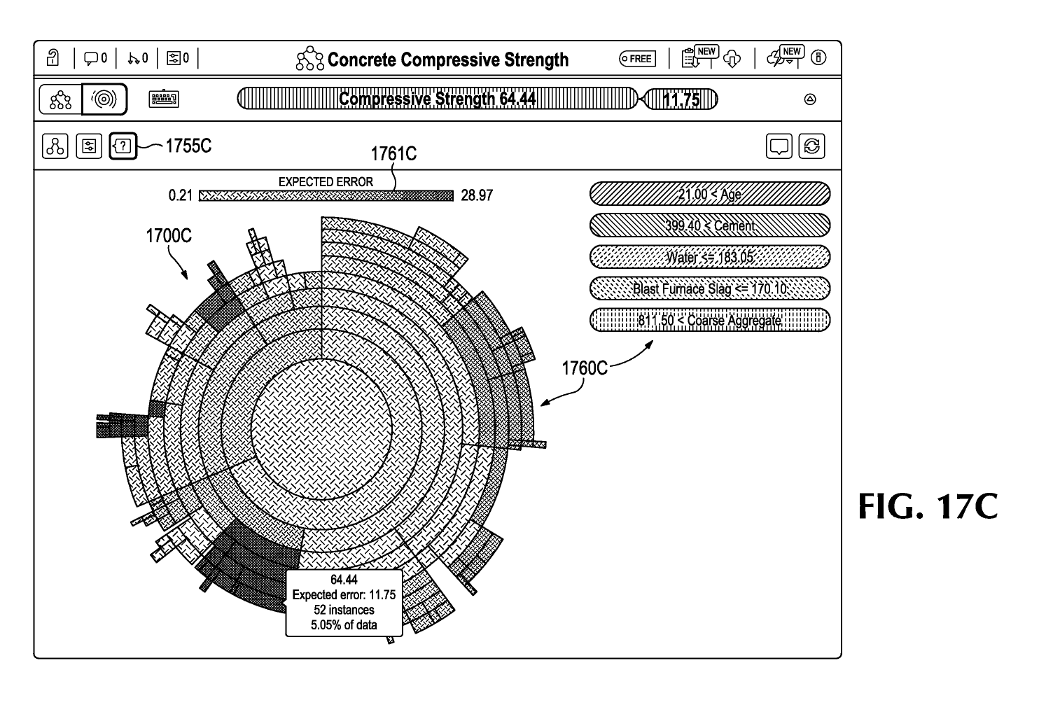

Visualization system 115 may display a tree visualization icon 1680 and a sunburst visualization icon 1690 that may be used to switch between display of prediction tree 1600A and sunburst 1700 (FIG. 17).

FIG. 16B is an embodiment of a pruned prediction tree 1600B according to the present invention. Referring to FIG. 16B, visualization system 115 may receive an indication of a user selecting a particular node, e.g., terminal node 1607. In response, visualization system 115 may redraw, re-render, or otherwise redisplay prediction tree 1600A as pruned prediction tree 1600B in which nodes and branches that are not associated with prediction path 1620 from terminal node 1607 to root node 1601 are hidden or otherwise not visible to improve analysis of prediction tree 1600A. Visualization system 115 may resize pruned prediction tree 1600B such that it occupies a substantial portion of the display area. Visualization system 115 may additionally display legend 1654 including boxes 1654A-1654G corresponding to root node 1601, nodes 1602, 1603, 1604, 1605, and 1606, and terminal node 1607 of pruned prediction tree 1600B.

Further in response to receiving an indication of a user selecting a particular node, e.g., terminal node 1607, visualization system 115 may display a pop up window 1640C as shown in FIG. 16C. Pop up window 1640C may display information associated with terminal node 1607, e.g., predicted value (i.e., compressive strength), expected error, histogram of data item instances, number of instances, and a percentage of data represented by the number of instances.

FIG. 16D is an embodiment of a further pruned prediction tree 1600D according to the present invention. Referring to FIG. 16D, visualization system 115 may receive an indication of a user's selection of a particular node, e.g., node 1605. In response, visualization system 115 may redraw, re-render, or otherwise redisplay pruned prediction tree 1600B as further pruned prediction tree 1600D in which nodes and branches that are not associated with a prediction path 1620D from node 1605 (and optionally child nodes 1606A and 1606B) to root node 1601 are hidden or otherwise not visible. Visualization system 115 may resize further pruned prediction tree 1600D relative to pruned prediction tree 1600A or pruned prediction tree 1600B such that it occupies a substantial portion of the display area. Visualization system 115 may additionally display legend 1654 including boxes 1654A-1654E corresponding to root node 1601, nodes 1602, 1603, 1604, 1605, 1606A, and 1606B of pruned prediction tree 1600D.

Further in response to receiving an indication of a user's selection of a particular node, e.g., node 1605, visualization system 115 may display a pop up window 1640E as shown in FIG. 16E. Pop up window 1640E may display information associated with a selected node, e.g., node 1605. Pop up window 1640E may display information, e.g., predicted value (i.e., compressive strength), expected error, histogram of data item instances, number of instances, and a percentage of data represented by the number of instances.

FIG. 16F is an embodiment of a further pruned prediction tree 1600F according to the present invention. Referring to FIG. 16F, visualization system 115 may receive an indication of a user's selection of a particular node, e.g., node 1604. In response, visualization system 115 may redraw, re-render, or otherwise redisplay pruned prediction tree 1600D as further pruned prediction tree 1600F in which nodes and branches that are not associated with a prediction path 1620F from node 1604 (and optionally child nodes 1605A and 1605B) to root node 1601 are hidden or otherwise not visible. Visualization system 115 may resize further pruned prediction tree 1600F relative to prediction tree 1600A or pruned prediction trees 1600B or 1600D such that it occupies a substantial portion of the display area. Visualization system 115 may additionally display legend 1654 including boxes 1654A-1654D corresponding to root node 1601, nodes 1602, 1603, 1604, 1605A, and 1605B of pruned prediction tree 1600D.

Further in response to receiving an indication of selection of a particular node, e.g., node 1604, visualization system 115 may display a pop up window 1640G as shown in FIG. 16G. Pop up window 1640G may display information associated with a selected node, e.g., node 1604. Pop up window 1640G may display information, e.g., predicted value (i.e., compressive strength), expected error, histogram of data item instances, number of instances, and a percentage of data represented by the number of instances.

FIG. 17A is an embodiment of a split field sunburst visualization according to the present invention. A sunburst is a space-filling graphical visualization that is an alternative to displaying large datasets as trees with nodes and branches. It is termed space-filling to denote the visualization's use of space on a display or otherwise to represent the distribution of attributes in hierarchical data.

In a sunburst, fields of data items in a hierarchy are laid out as radial segments, with the top of the hierarchy shown as a center segment and deeper levels shown as segments farther away from the center segment. The angle swept out by a segment may correspond to an attribute of the dataset and a color of a segment may correspond to another attribute of the dataset.

Referring to FIG. 17A, split field sunburst 1700A comprises a plurality of segments, e.g., a center segment 1701 and segments 1702, 1703, 1704, 1705, and 1706 arranged radially around center segment 1701. Sunburst 1700A may have a binary structure meaning that at most, two segments emanate from each (parent) segment in the hierarchy. Each segment in sunburst 1700 may have an associated width to represent the hierarchy in the dataset. For example, the wider segments are closer to center segment 1701 and are thus higher up in the hierarchy.

Sunburst 1700A may have an associated color scheme 1760A that comprises an arrangement of visual characteristics applied to the plurality of segments in response to a type of sunburst visualization. Visual characteristics may comprise color, cross-hatching, and any other characteristic capable of visually distinguishing one segment from another or one type of sunburst from another. Each segment may have a particular visual characteristic in the arrangement depending on a type of information to be graphically conveyed with the particular visual characteristic.

The type of sunburst visualization may comprise split field, prediction, or confidence (or expected error for numerical field values) and may be selected using split field icon 1755A, prediction icon 1755C, or confidence/expected error icon 1755B, respectively. Legend 1754 may display fields and/or values of each segment. Legend may include boxes, e.g., boxes 1754A-E that reflect the color scheme 1760A applied to sunburst 1700A. For example, box 1754A displays field (“age”) and value (“>21”) information corresponding to center segment 1701 and box 1754B displays field (“cement”) and value (“>399.40”) information corresponding to segment 1702, and so on.

Sunburst 1700A is a split field sunburst where color scheme 1760A may include an arrangement of colors (indicated as cross-hatching in FIG. 17A) to indicate fields in the dataset. Each segment in sunburst 1700A may be represented with a particular color in color scheme 1760A.

By selecting prediction icon 1755B, visualization system 115 may display a prediction sunburst 1700B with color scheme 1760B as shown in FIG. 17B. By selecting confidence/expected error icon 1755C, visualization system 115 may display a confidence sunburst 1700C with color scheme 1760C as shown in FIG. 17C. Note that the sunbursts 1700A, 1700B, and 1700C have an identical arrangement of segments with a different color scheme 1760A, 1760B, and 1760C to convey different information, e.g., split field values (split field), predictive value (prediction), or confidence level or expected error in the prediction (confidence), respectively. As shown in FIG. 17B, a range of predictive compressive strength is shown in color-coded bar 1761B that is consistent with color scheme 1760B. Similarly in FIG. 17C, an expected error (or conversely, a confidence level in the case of categorical values) is shown in color-coded bar 1761C.

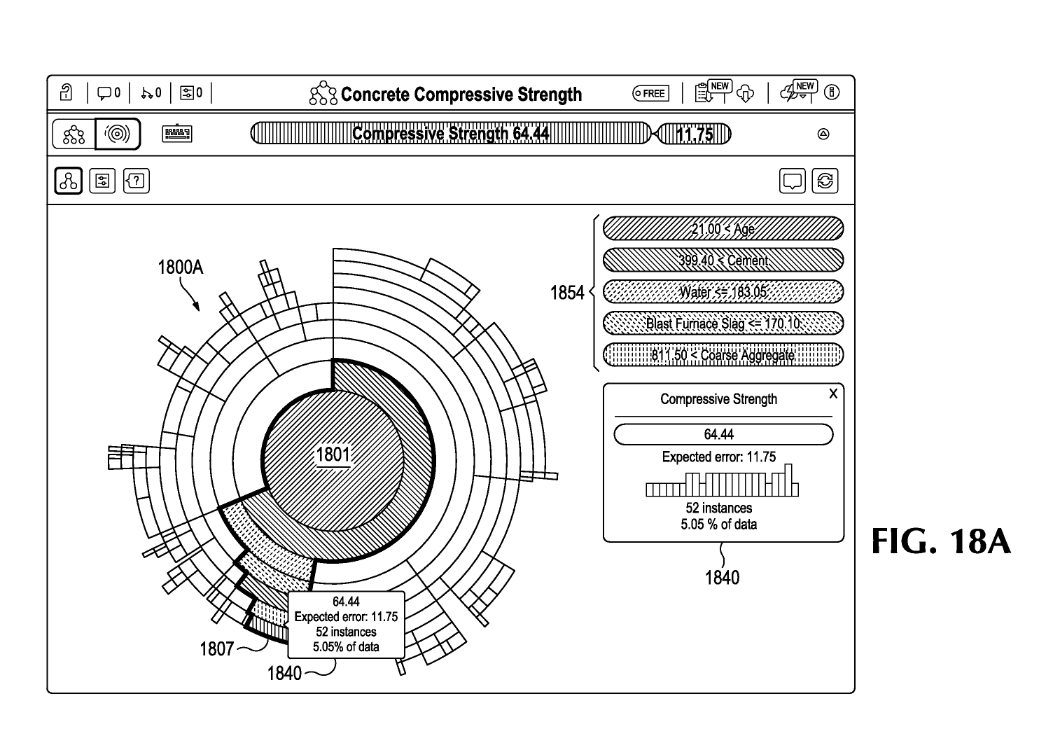

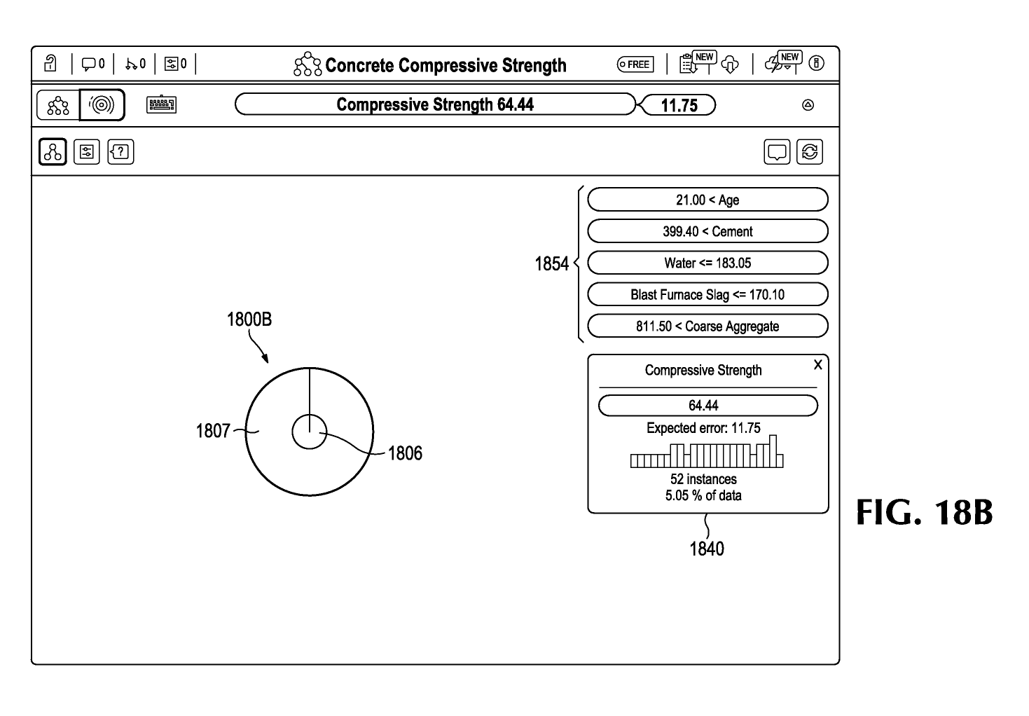

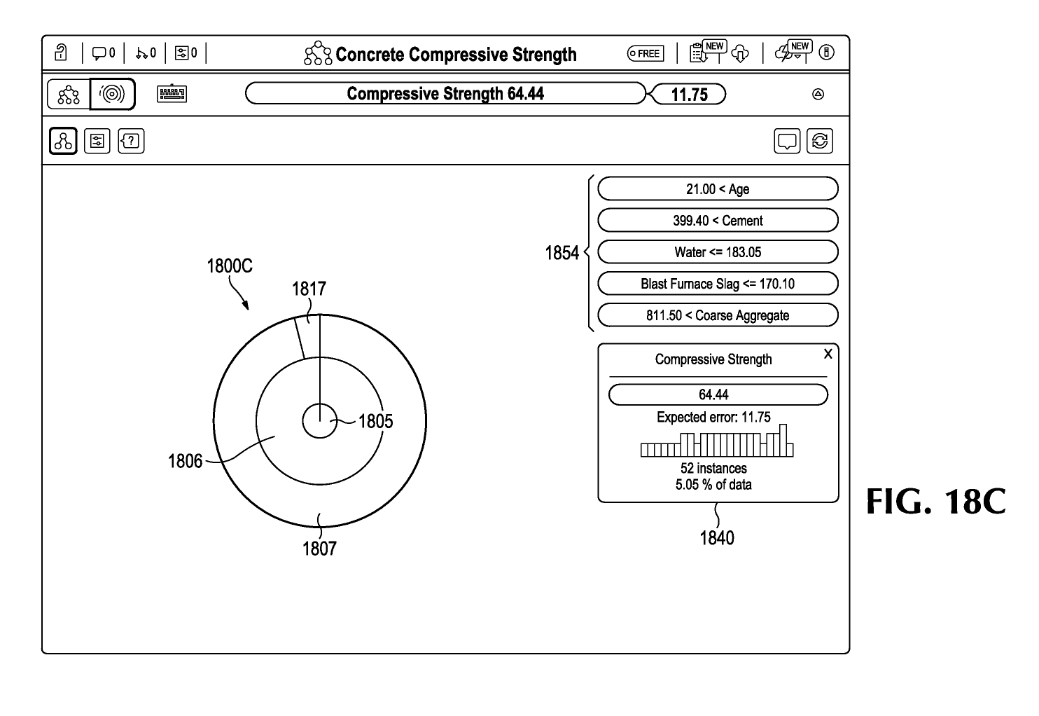

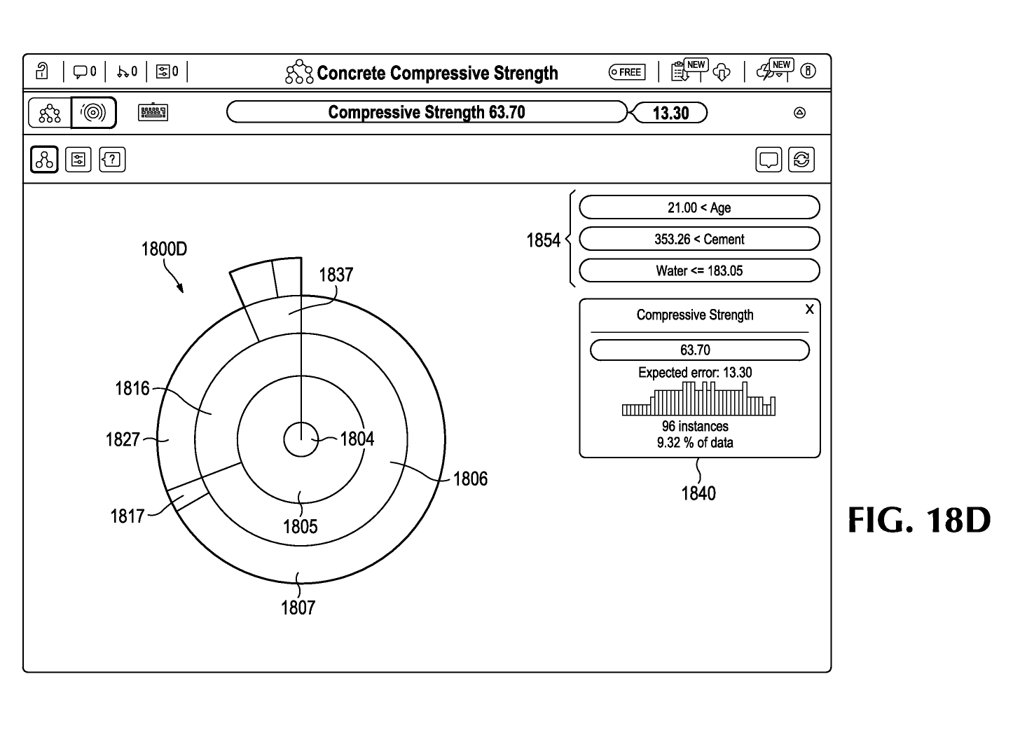

FIG. 18A is an embodiment of a split field sunburst 1800A according to the present invention. Referring to FIG. 18A, visualization system 115 may receive an indication that a user has selected a particular segment, e.g., segment 1807, on sunburst 1800A. The user may indicate selection of segment 1807 by any means known to a person of ordinary skill in the art including clicking on segment 1807 using any kind of mouse, hovering over segment 1807 for a predetermined amount of time using any kind of cursor, touching segment 1807 as displayed using any kind of touch screen, gesturing over segment 1807, and the like. In response to receiving the indication that the user has selected segment 1807, visualization system 115 may visually highlight a prediction path from center segment 1801 to selected segment 1807. Note that in FIG. 18A, only the prediction path from center segment 1801 to selected segment 1807 is shown with the cross-hatching or colors corresponding to segments within the prediction path but other manners of visual highlighting are encompassed within the invention, including making segments in the prediction path brighter or differently colored relative to other segments. Legend 1854 will likewise change to provide information specific to the selected segment 1807 including showing a pop up window 1840 displaying further information specific to segment 1807 including a predicted value (or category), expected error in the prediction, histogram, number of instances encompassed in the prediction, a percentage that the number of instances encompassing the prediction represents, and the like. Visualization system 115 may display pop up window 1840 in any of a variety of locations including over selected segment 1807 or beneath legend 1854.

Note further that selection of segment 1807 is merely exemplary and any segment of sunburst 1800A may be selected to achieve similar results, i.e., the highlighting of a prediction path between the selected segment and center segment 1801.

FIG. 18B is an embodiment of a pruned sunburst 1800B. Referring to FIG. 18B, in response to the selection of segment 1807, visualization system 115 may prune, filter, re-render, or redraw sunburst 1800A (shown in FIG. 18A) as pruned (or zoomed in) sunburst 1800B in which is displayed only selected segment 1807 and segment 1806. Note that segment 1806 is a segment one level up on the hierarchy from segment 1807 along the prediction path from segment 1807 to center segment 1801. Note further that visualization system 115 may display segment 1806 as a center segment of sunburst 1800B to enable further re-rendering (zooming out) of sunburst 1800B.

Selection of (center) segment 1806 in sunburst 1800B may result in visualization system 115 re-rendering (zooming out) sunburst 1800B as sunburst 1800C shown in FIG. 18C. Sunburst 1800C comprises segment 1807 and 1817 as outermost segments surrounding segment 1806 and segment 1805. Note that segment 1805 is a segment one level up on the hierarchy from selected segment 1806 along the prediction path from segment 1807 to center segment 1801. Note further that visualization system 115 may display segment 1805 as a center segment of sunburst 1800C to enable further re-rendering (zooming out) of sunburst 1800C.

Selection of (center) segment 1805 in sunburst 1800C may result in visualization system 115 re-rendering (zooming out) sunburst 1800C as sunburst 1800D shown in FIG. 18D. Sunburst 1800D comprises segment 1807, 1817, 1827, and 1837 as outermost segments surrounding segments 1806, 1816, 1805, and 1804. Note that segment 1804 is a segment one level up on the hierarchy from selected segment 1805 along the prediction path from segment 1807 to center segment 1801. Note further that visualization system 115 may display segment 1804 as a center segment of sunburst 1800D to enable further re-rendering (zooming out) of sunburst 1800D. Generally, selection of a center segment in any sunburst may result in re-rendering (zooming out) of the sunburst with an additional hierarchical level of segments until a full sunburst, e.g., sunburst 1800A, is displayed.

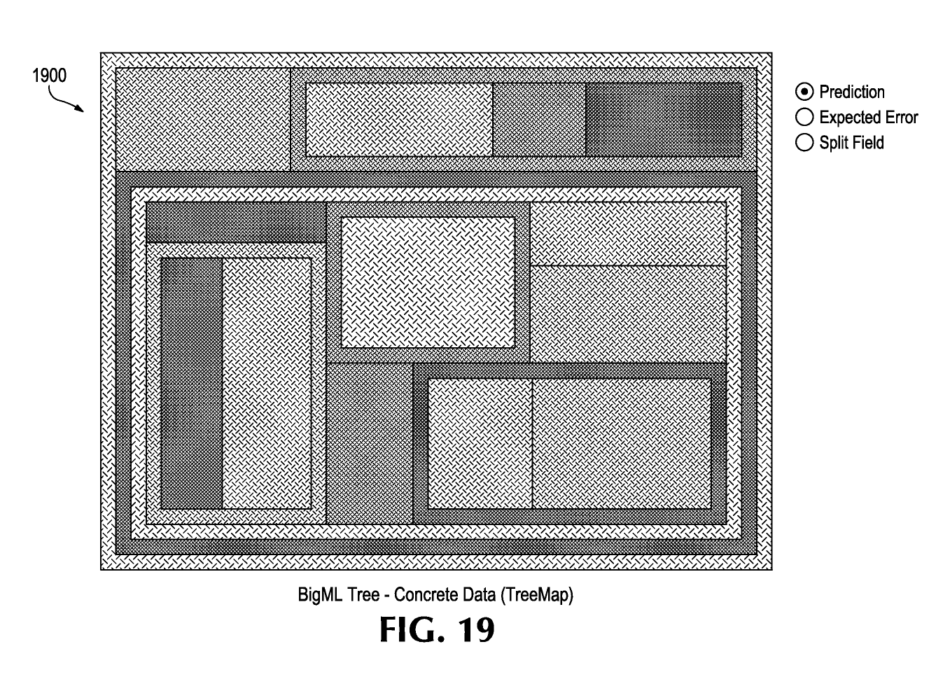

FIG. 19 is an embodiment of tree map 1900 according to the present invention. Referring to FIG. 19, tree map 1900 is an alternative space-filling visualization to sunbursts 1700A, 1700B, or 1700C in which hierarchical data may be depicted using nested rectangles. Each branch of the tree is given a rectangle that is tiled with smaller rectangles representing sub branches. Each rectangle may have an area proportional to a first attribute of the data and a color corresponding to a second attribute of the data.

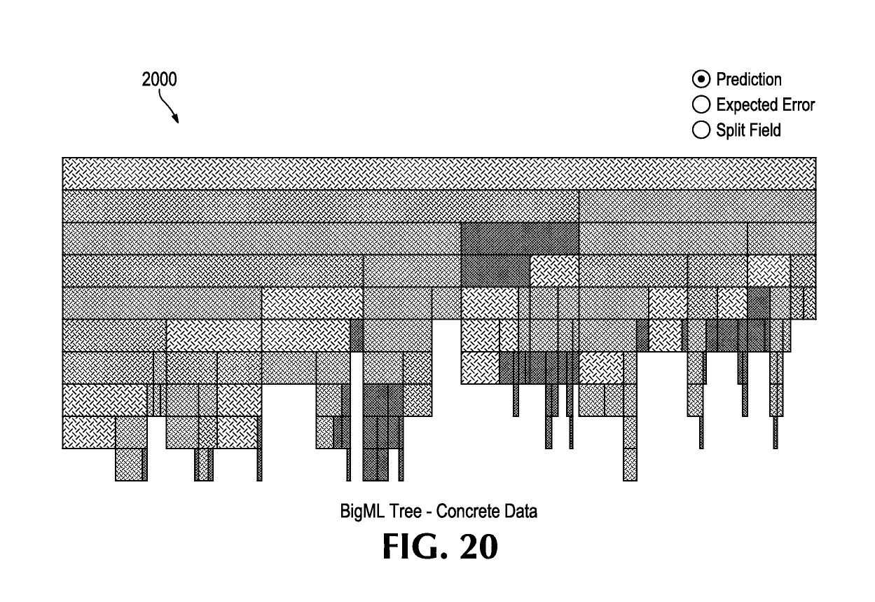

FIG. 20 is an embodiment of an icicle 2000 according to the present invention. Referring to FIG. 20, icicle 2000 is another alternative space-filling visualization to sunbursts 1700A, 1700B, or 1700C in which hierarchical data may be depicted as solid bars and their placement relative to adjacent nodes reveals their position in the hierarchy. In icicle 2000, the root node is at the top with child nodes underneath.

Visualization system 115 may generate tree map 1900 or icicle 2000 as well as other like space-filling visualizations instead of sunbursts 1700A, 1700B, or 1700C and may use any space-filling visualization, e.g., sunburst 1700A, 1700B, or 1700C, tree map 1900, or icicle 2000 interchangeably as described herein.

Having described and illustrated the principles of a preferred embodiment, it should be apparent that the embodiments may be modified in arrangement and detail without departing from such principles. Claim is made to all modifications and variation coming within the spirit and scope of the following claims.

1. A method, comprising:
accessing a model based at least in part on a dataset comprising data items;
receiving an indication of a type of visualization to be displayed;
generating a space-filling graphical representation of the model on a computing device, the space-filling graphical representation comprising a plurality of segments arranged to realize the indicated type of visualization;
displaying the space-filling graphical representation of the model on a display screen of the computing device;
wherein each segment represents a corresponding subset of the data items; and
wherein each of the plurality of segments is sized in proportion to a number of instances of the data items represented by the segment.

2. The method of claim 1, further comprising:
providing a color scheme based at least in part on the indicated type of visualization; and
displaying the graphical representation of the model on the display screen using the color scheme.

3. The method of claim 2, further comprising:
receiving the indication of a split field visualization; and
applying to the space-filling graphical representation, a split field color scheme comprising an arrangement of colors based on a field value corresponding to each segment.

4. The method of claim 2, further comprising:
receiving the indication of a prediction visualization; and
applying to the space-filling graphical representation, a prediction color scheme comprising an arrangement of colors based on a prediction corresponding to each segment.

5. The method of claim 2, further comprising:
receiving the indication of a confidence visualization; and
applying to the space-filling graphical representation, a confidence color scheme comprising an arrangement of colors based on a confidence or expected error attribute corresponding to each segment.

6. The method of claim 5, further comprising:
displaying a confidence value or an expected error in response to selection of a segment in the graphical representation having associated therewith a categorical or numerical value, respectively.

7. The method of claim 1, further comprising:
receiving an indication of another type of visualization;
providing another color scheme based at least in part on the indicated another type of visualization; and
displaying the graphical representation of the model using the another color scheme.

8. The method of claim 1, further comprises:
receiving an indication of a selected segment; and
visually highlighting a series of segments from the selected segment to a segment at a topmost hierarchical level of the space-filling graphical representation in response to receiving the indication of the selected segment.

9. The method of claim 8, further comprising:
displaying secondary information corresponding to each of the segments in the series of segments from the selected segment to the segment at the topmost hierarchical level in response to receiving the indication of the selected segment.

10. The method of claim 1, further comprising:
receiving an indication of a selected segment; and
replacing displaying the space-filling graphical representation of the model with displaying a modified graphical representation of the model on the display screen of the computing device, the modified graphical representation of the model comprising only the selected segment, a subset of segments corresponding to the selected segment at hierarchical levels below the selected segment, and a center segment corresponding to the selected segment at a hierarchical level above the selected segment.

11. The method of claim 10, further comprising:
receiving an indication of selecting the center segment in the modified graphical representation; and
replacing displaying the modified graphical representation of the model with a further modified graphical representation of the model, the further modified graphical representation of the model comprising only the selected segment, the subset of segments corresponding to the selected segment at the hierarchical levels below the selected segment, at least another segment corresponding to a hierarchical level immediately above the center segment of the modified graphical representation, and a new center segment corresponding to a segment at a hierarchical level above the center segment of the modified graphical representation.

12. The method of claim 2, further comprising:
arranging the plurality of segments radially surrounding a center segment;
displaying each of the plurality of segments with a unique color from the color scheme; and
displaying each of the plurality of segments with an angle corresponding to an attribute of the data items represented by the segment.

13. A system, comprising:
a model generator configured to generate a model on a computing device based at least in part on a dataset having at least one source of data items; and
a visualization system configured to:
receive an indication of a type of visualization to be displayed;
generate a graphical representation of the model on a computing device, the graphical representation comprising a plurality of segments each segment representing a unique subset of the data items;
provide a color scheme based at least in part on the type of visualization; and
display the graphical representation of the model on a display screen of the computing device using the provided color scheme;
wherein each of the plurality of segments is sized in proportion to a number of the data items represented by the segment.

14. The system of claim 13, wherein the type of visualization comprises a split field visualization, a prediction visualization, or a confidence visualization.

15. The system of claim 14,
wherein the type of visualization is the split field visualization; and
wherein the color scheme is the split field color scheme comprising an arrangement of colors based on the number of instances of the data items corresponding to each segment.

16. The system of claim 14,
wherein the type of visualization is the prediction visualization; and
wherein the color scheme is the prediction color scheme comprising an arrangement of colors based on a prediction attribute of the data items corresponding to each segment.

17. The system of claim 14,
wherein the type of visualization is the confidence visualization; and
wherein the color scheme is the confidence color scheme comprising an arrangement of colors based on a confidence attribute corresponding to the data items corresponding to each segment.

18. The system of claim 17, wherein the visualization system is further configured to:
receive an indication of a selected segment; and
display, in response to the indication, a confidence value or an expected error in a prediction associated with the selected segment representing categorical values or numerical values, respectively.

19. The system of claim 13, wherein the visualization system is further configured to:
receive an indication of another type of visualization;
provide another color scheme based at least in part on the another type of visualization; and
display the graphical representation of the model using the another color scheme.

20. The system of claim 13,
wherein the plurality of segments represent a corresponding plurality of hierarchical levels; and
wherein the visualization system is further configured to:
receive an indication of a selected segment; and
visually highlight a series of segments from the selected segment to a segment at a topmost hierarchical level.

21. The system of claim 20, wherein the visualization system is further configured to:
display secondary information corresponding to each of the segments in the series of segments from the selected segment to the segment at the topmost hierarchical level.

22. The system of claim 13, wherein the visualization system is further configured to:
receive an indication of a selected segment; and
replace displaying the graphical representation of the model with displaying a first modified graphical representation of the model on the display screen of the computing device, the modified graphical representation of the model comprising only the selected segment, a subset of segments corresponding to the selected segment at hierarchical levels below the selected segment, and a center segment corresponding to the selected segment at a hierarchical level above the selected segment.

23. The system of claim 22, wherein the visualization system is further configured to:
receive an indication of selecting the center segment; and
replace displaying the first modified graphical representation of the model with a second modified graphical representation of the model, the second modified graphical representation of the model comprising only the selected segment, the subset of segments corresponding to the selected segment at the hierarchical levels below the selected segment, at least another segment corresponding to a hierarchical level immediately above the center segment, and new center segment corresponding to a segment at a hierarchical level above the center segment.

24. The system of claim 13, wherein the visualization system is further configured to:
arrange the plurality of segments radially surrounding a center segment;
display each of the plurality of segments with a unique color from the color scheme; and
display each of the plurality of segments is displayed with an angle corresponding to an attribute of the data items.
